(19) United States
(12) Patent Application Publication
(10) Pub. No.: US 2025/0165591 A1
(43) Pub. Date: May 22, 2025

(54) METHODS AND MECHANISMS TO PERFORM AUTOMATED CLASSIFICATIONS OF ANOMALOUS TRACE SHAPES

(71) Applicant: Applied Materials, Inc., Santa Clara, CA (US)

(72) Inventors: Peter J. Lindner, Saratoga Springs, NY (US); Chih Wei Lin, Hsinchu City (TW); Jimmy Iskandar, Fremont, CA (US); Michael D. Armacost, San Jose, CA (US)

(21) Appl. No.: 18/513,930

(22) Filed: Nov. 20, 2023

(51) Int. Cl. G06F 21/55; G06N 20/20

(52) U.S. Cl. CPC G06F 21/554; G06N 20/20; G06F 2221/034

(57) ABSTRACT

A system configured to obtain current trace data associated with a substrate processing system and provide the trace data as input to a first predictive subsystem trained to detect anomalies using a first technique. Responsive to detecting an anomaly in the trace data, the system provides the trace data as input to a second predictive subsystem trained to detect anomalies using a second technique. Output data obtained from the first predictive subsystem and the second predictive subsystem is provided to a third predictive subsystem. Output data from the third predictive subsystem is obtained. The output data is reflective of a trace shape associated with the anomaly. Based on the trace shape, a type of issue that caused the anomaly in the trace data is identified.

### TECHNICAL FIELD

The present disclosure relates to methods and mechanisms for performing automated classifications of anomalous trace shapes.

### BACKGROUND

Manufacturing of modern materials often involves various deposition techniques, such as chemical vapor deposition (CVD) or physical vapor deposition (PVD) techniques, in which atoms or molecules of one or more selected types are deposited on a semiconductor device (e.g., a substrate) held in low or high vacuum environments that are provided by vacuum processing (e.g., deposition, etching, etc.) chambers. Materials manufactured in this manner can include monocrystals, semiconductor films, fine coatings, and numerous other substances used in practical applications, such as electronic device manufacturing. Many of these applications depend on the purity and specifications of the materials grown in the processing chambers. The quality of such materials, in turn, depend on adherence of the manufacturing operations to correct process specifications. To maintain isolation of the inter-chamber environment and to minimize exposure of substrates to ambient atmosphere and contaminants, various sensor detection techniques are used to monitor processing chamber environment, substrate transportation, physical and chemical properties of the products, and the like to detect potential anomalies and issues. Improving precision, reliability, and efficiency of such monitoring presents a number of technological challenges whose successful resolution facilitates continuing progress of electronic device manufacturing and helps to meet the constantly increasing demands to the quality of the products of semiconductor device manufacturing.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a system is configured to obtain current trace data associated with a substrate processing system and provide the trace data as input to a first predictive subsystem trained to detect anomalies using a first technique. Responsive to detecting an anomaly in the trace data, the system provides the trace data as input to a second predictive subsystem trained to detect anomalies using a second technique. Output data obtained from the first predictive subsystem and the second predictive subsystem is provided to a third predictive subsystem. Output data from the third predictive subsystem is obtained. The output data is reflective of a trace shape associated with the anomaly. Based on the trace shape, a type of issue that caused the anomaly in the trace data is identified.

A further aspect of the disclosure includes a method according to any aspect or implementation described herein.

A further aspect of the disclosure includes a non-transitory computer-readable storage medium comprising instructions that, when executed by a processing device operatively coupled to a memory, performs operations according to any aspect or implementation described herein.

### BRIEF DESCRIPTION OF THE DRAWINGS

The present disclosure is illustrated by way of example, and not by way of limitation in the figures of the accompanying drawings.

FIG. 1 is a block diagram illustrating an example system architecture, in accordance with some implementations of the present disclosure.

FIG. 2 is a top schematic view of an example manufacturing system, in accordance with some implementations of the present disclosure.

FIG. 3 is a block diagram illustrating an example predictive architecture, in accordance with some implementations of the present disclosure.

FIG. 4 is an exemplary illustration of a machine-learning system that is capable of anomaly detection based on statistics using neural networks, in accordance with some implementations of the present disclosure.

FIG. 5 is an exemplary illustration of a reduction stage of anomaly detection based on aggregate statistics using neural networks, in accordance with some implementations of the present disclosure.

FIG. 6 is an exemplary illustration of a detection stage of anomaly detection based on aggregate statistics using neural networks, in accordance with some implementations of the present disclosure.

FIG. 7 is an exemplary neural network that operates as a detector neural network used in the detection stage of anomaly detection based on aggregate statistics using neural networks, in accordance with some implementations of the present disclosure.

FIG. 8 is a flow chart of a method for detecting an anomaly using an ensemble technique system, in accordance with some implementations of the present disclosure.

FIG. 9 is diagram illustrating an ADE system detecting an anomaly, in accordance with some implementations of the present disclosure.

FIGS. 10A-D are flow diagrams of methods associated with generating a guardband, in accordance with some implementations of the present disclosure.

FIG. 11 illustrates an example guardband violation profiling, in accordance with some implementations of the present disclosure.

FIG. 12 is a diagram of the framework for building (e.g., training) a trace shape classifier model, according to aspects of the present disclosure.

FIG. 13 is a flow chart of a method for detecting an anomaly and applying a trace shape classifier model to anomalous current trace data to classify an anomalous trace shape, according to aspects of the present disclosure.

FIGS. 14A-14E illustrate a set of example anomalous trace shapes, in accordance with aspects of the present disclosure.

FIG. 15 is a block diagram illustrating a computer system, according to certain implementations.

### DETAILED DESCRIPTION

Described herein are technologies directed to methods and mechanisms for performing automated classifications of anomalous trace shapes. In particular, the implementations can monitor different components and sub-systems across multiple process chambers and accurately detect when an anomaly in a manufacturing process and/or a product of the process arises that indicates a deterioration of the product yield. A sub-system can refer to a pressure sub-system, a flow sub-system, a temperature sub-system and so forth, each sub-system having one or more components. The component can include, for example, a pressure pump, a vacuum, a gas deliver line, etc. Further, the implementations disclosed can help accurately identify and/or classify the detected anomalies based on the shape of the trace data obtained from one or more sensors. Trace data refers to sensor data received over a period of time (e.g., corresponding to at least part of a recipe or run).

The robotic delivery and retrieval of substrates, as well as maintaining controlled environments in loading, processing, and transfer chambers improve speed, efficiency, and quality of the semiconductor device manufacturing. Typical semiconductor device manufacturing processes often require tens or hundreds of steps, e.g., introducing a gas into a processing chamber, heating the chamber environment, changing a composition of gas, purging a chamber, pumping the gas out, changing pressure, moving a substrate from one position to another, creating or adjusting a plasma environment, performing etching or deposition steps, and so on. The very complexity of the semiconductor manufacturing technology requires processing a constant stream of run-time data from various sensors placed inside the manufacturing system. Such sensor can include temperature sensors, pressure sensors, chemical sensors, gas flow sensors, motion sensors, position sensor, optical sensors, and other types of sensors. The manufacturing system can have multiple sensors of the same (or similar) type distributed throughout various parts of the system. For example, a single processing chamber can have multiple chemical sensors to detect concentration of chemical vapor at various locations within the processing chamber and can similarly have multiple temperature sensors to monitor a temperature distribution. Some or all of the sensors can output a constant stream of data. For example, a temperature sensor can output a temperature reading ever second (or more frequently) so that a single etching step that takes several minutes to perform can be generate hundreds of data points (referred to as trace data) from this sensor alone.

Each sensor (alone or in combination with other sensors) can output data that is indicative of a sudden or gradual detrimental changes in the environment or in the settings of the manufacturing process. In addition, similar sensors in different process chambers can exhibit distinct behavior (e.g., deterioration rate, output variations, etc.), especially after each respective process chamber is subjected to a maintenance routine. In some systems, a detection system can read the data and monitor whether the manufacturing process conforms to the process specifications. However, these detection systems simply indicate which sensor or recipe step includes the anomaly but fail to identify the type of issue that occurred or the potential root causes of the issue.

Aspects and implementations of the present disclosure address these and other shortcomings of the existing technology by automatically detecting and classifying anomalous traces. In particular, the system of the present disclosure can implement a first anomaly detection model (e.g., a first trained machine-learning model configured to perform anomaly detection operations) to process current trace data associated with one or more substrate fabrication (or manufacturing) processes. In an illustrative example, the first anomaly detection model can include a trained machine-learning model configured to detect anomalies using ensemble techniques. Ensemble technique models use training sets of sensor statistics to establish a baseline, and are trained to detect outliers (e.g., certain values) that deviate by a threshold value from the baseline. Once an anomaly is detected, the system of the present disclosure can process the anomalous trace data through a second anomaly detection model. The second anomaly detection model can be another trained machine-learning model configured to provide additional data about the anomalous trace data than the first anomaly detection model. The additional data can include details about the anomalous trace data that the first anomaly detection model is not configured to provide. In an illustrative example, the second anomaly detection model can include a trained machine-learning model configured to perform a trace analysis method. The trace analysis method can generate adaptive upper and lower limits (which reflect an allowable margin of error) around target values. Sensor data can be compared to these limits to determine whether the sensor data is within threshold values or outside of the threshold values. Trace data outside these limits can be referred to as violation trace data. In is noted that certain anomaly detection models, such as those that use ensemble techniques, can require fewer computing resources (e.g., processing power, memory, etc.) than other anomaly detection models, such as those using the trace analysis method. As such, by implementing the first anomaly detection model to detect anomalies during a substrate manufacturing process and then obtaining additional data about the anomalous data using the second anomaly detection model, considerable computing resources can be preserved by not running second anomaly detection model through the entire fabrication process.

The anomaly data obtained from the first anomaly detection model and the second anomaly detection model can be used as input to a trace shape classifier model configured to determine a trace shape associated with the anomaly data. As an illustrative example, the trace shape can include an offset shape, a spike shape, an oscillation shape, a noise shape, a shark fin shape, etc. Each shape can be indicative of a different issue that occurred during the manufacturing process. For example, a shark fin trace shape can be indicative of electrical issues or timing issues. Accordingly, the system of the present disclosure can determine the type of issue or root cause of the anomaly by, for example, performing a lookup of the anomalous trace shape in a database. The database can correlate anomalous trace shapes to their corresponding identification data (data used to identify the type or behavior of the anomaly) and/or root causes. In some implementations, the system can perform a corrective action based on the identified anomalous trace shape. A corrective action can include one or more operations performed to adjust an operating condition (e.g., a parameter of a process recipe) of a process chamber during a process run. For example, a corrective action can include increasing heater current, decrease gas flowrate, etc. Accordingly, the system can perform a lookup of a corresponding corrective action for the identified anomalous trace shape.

Aspects of the present disclosure result in technological advantages of improving the accuracy of manufacturing anomaly detection techniques during a manufacturing process. In one example, the aspects of the present disclosure can detect an anomaly, classify the anomaly (e.g., identify the type of anomaly) based on trace data (e.g., a trace shape) and identify the cause of the anomaly, allowing for accurate corrective actions to be performed. This can result in generating detailed diagnostic data, which can reduce fabrication of inconsistent and abnormal products, and prevent unscheduled user time or downtime. Additionally, aspects of the present disclosure provide significant reduction in time and data required to process the sensor data to detect the possible anomalies.

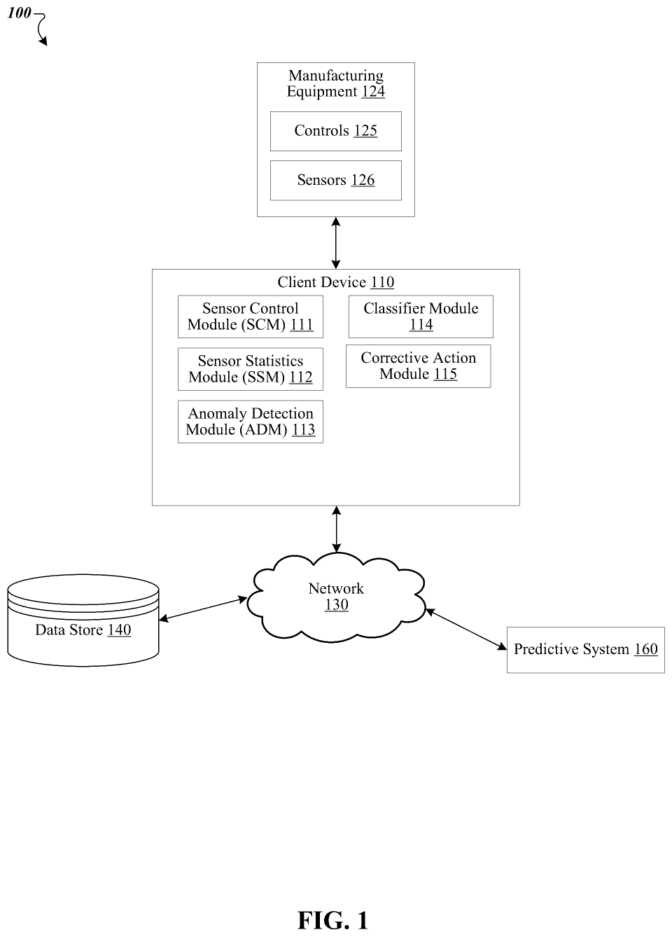

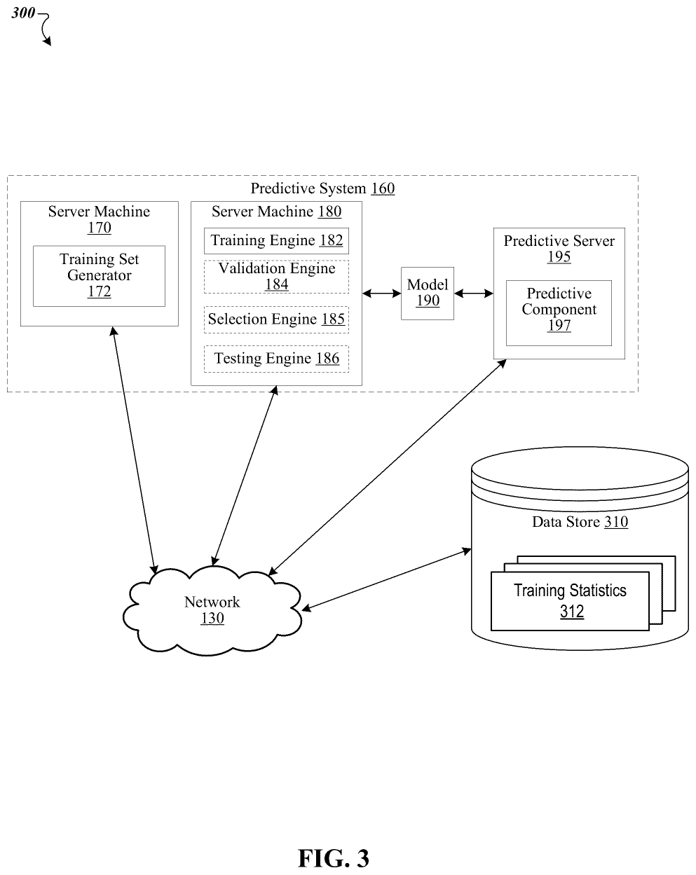

FIG. 1 depicts an illustrative computer system architecture 100, according to aspects of the present disclosure. In some implementations, computer system architecture 100 can be included as part of a manufacturing system for processing substrates. Computer system architecture 100 includes a client device 110, manufacturing equipment 124, predictive system 160 (e.g., to generate predictive data, to provide model adaptation, to use a knowledge base, etc., which will be described in detail in FIG. 3), and data store 140. The manufacturing equipment 124 can include sensors 126 configured to capture data for a substrate being processed at the manufacturing system. In some implementations, the manufacturing equipment 124 and sensors 126 can be part of a sensor system that includes a sensor server (e.g., field service server (FSS) at a manufacturing facility) and sensor identifier reader (e.g., front opening unified pod (FOUP) radio frequency identification (RFID) reader for sensor system). In some implementations, metrology equipment can be part of computer system architecture 100 that includes a metrology server (e.g., a metrology database, metrology folders, etc.) and metrology identifier reader (e.g., FOUP RFID reader for metrology system).

Manufacturing equipment 124 can produce products, such as electronic devices, following a recipe or performing runs over a period of time. Manufacturing equipment 124 can include a process chamber. Manufacturing equipment 124 can perform a process for a substrate (e.g., a wafer, etc.) at the process chamber. Examples of substrate processes include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

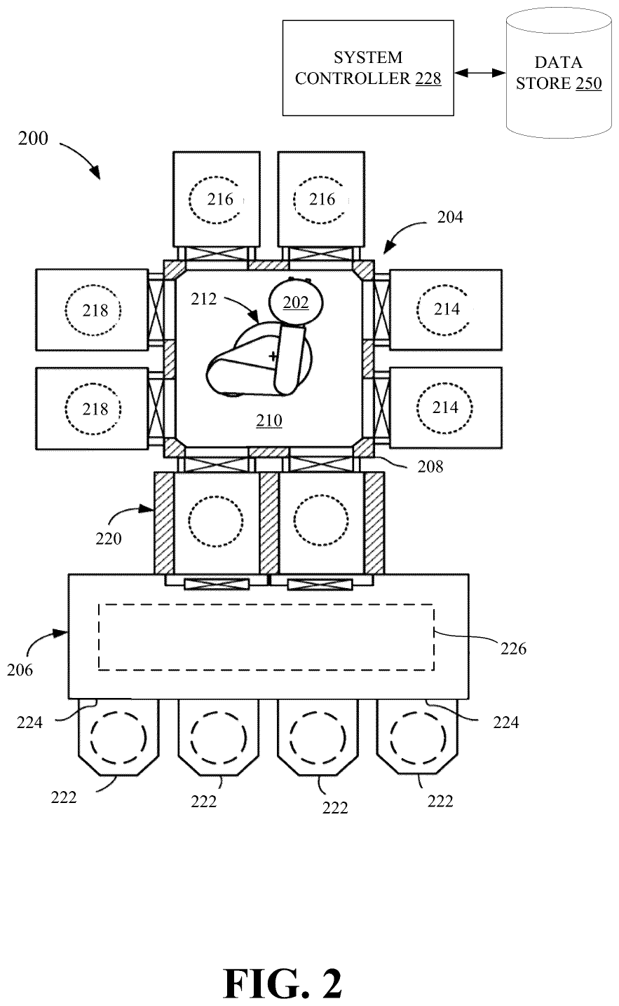

In some implementations, manufacturing equipment 124 includes sensors 126 that are configured to generate data associated with a substrate processed at manufacturing system 100. For example, a process chamber can include one or more sensors configured to generate spectral or non-spectral data associated with the substrate before, during, and/or after a process (e.g., a deposition process, an etch process, etc.) is performed for the substrate. In some implementations, spectral data generated by sensors 126 can indicate a concentration of one or more materials deposited on a surface of a substrate. Sensors 126 configured to generate spectral data associated with a substrate can include reflectometry sensors, ellipsometry sensors, thermal spectra sensors, capacitive sensors, and so forth. Sensors 126 configured to generate non-spectral data associated with a substrate can include temperature sensors, pressure sensors, flow rate sensors, voltage sensors, etc. For example, each sensor 126 can be a temperature sensor, a pressure sensor, a chemical detection sensor, a chemical composition sensor, a gas flow sensor, a motion sensor, a position sensor, an optical sensor, or any and other type of sensors. Some or all of the sensors 126 can include a light source to produce light (or any other electromagnetic radiation), direct it towards a target, such as a component of the machine 100 or a substrate, a film deposited on the substrate, etc., and detect light reflected from the target. The sensors 126 can be located anywhere inside the manufacturing equipment 124 (for example, within any of the chambers including the loading stations, on one or more robots, on a robot blade, between the chambers, and so one), or even outside the manufacturing equipment 124 (where the sensors can test ambient temperature, pressure, gas concentration, and so on). Further details regarding manufacturing equipment 124 are provided with respect to FIG. 2.

In some implementations, sensors 126 provide sensor data (e.g., sensor values, features, trace data) associated with manufacturing equipment 124 (e.g., associated with producing, by manufacturing equipment 124, corresponding products, such as substrates). The manufacturing equipment 124 can produce products following a recipe or by performing runs over a period of time. Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each substrate.

In some implementations, manufacturing equipment 124 can include controls 125. Controls 125 can include one or more components or sub-systems configured to enable and/or control one or more processes of manufacturing equipment 124. For example, a sub-system can include a pressure sub-system, a flow sub-system, a temperature sub-system and so forth, each sub-system having one or more components. The component can include, for example, a pressure pump, a vacuum, a gas deliver line, a plasma etcher, actuators etc. In some implementations, controls 125 can be managed based on data from sensors 126.

In some implementations, certain sensors 126 and controls 125 can be related to one or more control modules. In particular, each control module can include a set of sensors 126, controls 125, control logic regulating the sensors and/or components, etc. In an illustrative example, the controls modules can include a thermal control module, a plasma control module, a reactant flux control module, and a substrate control module. The thermal control module can include sensors and controls related to providing and maintain a heating environment in a process chamber (e.g., heater, heater sensor, etc.). The plasma control module can include sensors and controls related to creating or adjusting a plasma environment in a process chamber (e.g., plasma etcher, etcher sensor, etc.). The reactant flux control module can include sensors and controls related to the gas flow operations in a process chamber (e.g., gas flow control and sensor, pump, etc.). The substrate control module can include sensors and controls related to substrate properties (e.g., warp experience by a substrate). In certain implementations, sensor data from one or more of the particular control modules can be processed and analyzed, via modules 111-117 and the methods discussed herein, to control the respective operating conditions (e.g., a parameter of a process recipe) associated with said process control module.

The client device 110 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. In some implementations, the sensor data (or other data items) can be received from the client device 110. Client device 110 can display a graphical user interface (GUI), where the GUI enables the user to provide, as input, metrology measurement values for substrates processed at the manufacturing system. The client device 110 can include sensor control module (SCM) 111, sensor statistic module (SSM) 112, anomaly detection module (ADM) 113, classifier module 114, and corrective action module 115.

The SCM 111 can activate sensors, deactivate sensors, place sensors in an idle state, change settings of the sensors, detect sensor hardware or software problems, and so on. In some implementations, the SCM 111 can keep track of the processing operations performed by the manufacturing equipment 124 and determine which sensors 126 to be sampled for a particular processing (or diagnostic, maintenance, etc.) operation of the manufacturing equipment 124. For example, during a chemical deposition step inside one of the processing chambers, the SCM 111 can sample sensors 126 that are located inside the respective processing chamber but not activate (or sample) sensors 126 located inside the transfer chamber and/or the loading station. The raw data obtained by the SCM 111 can include time series data where a specific sensor 126 captures or generates one or more readings of a detected quantity at a series of times. For example, a pressure sensor can generate N pressure readings P (tᵢ) at time instances t₁, t₂, . . . t_{N}. In some implementations, the raw data obtained by the SCM 111 can include spatial maps at a pre-determined set of spatial locations. For example, an optical reflectivity sensor can determine reflectivity of a film deposited on the surface of a wafer, R (xⱼ, yₗ), at a set (e.g., a two-dimensional set) of spatial locations xⱼ, yₖ, on the surface of the film/wafer. In some implementations, both the time series and the spatial maps raw data can be collected. For example, as the film is being deposited on the wafer, the SCM 111 can collect the reflectivity data from various locations on the surface of the film and at a set of consecutive instances of time, R(tᵢ, xⱼ, yₗ).

SSM 112 can process the raw data obtained by the SCM 111 from the sensors 126 and determine statistics representative of the raw data (referred to as “statistics data”). For example, for each or some of the raw sensor data distributions, the SSM 112 can determine one or more parameters of the distribution, such as a mean, a median, a mode, an upper bound, a lower bound, a variance (or a standard deviation), a skewness (third moment), a kurtosis (fourth moment), or any further moments or cumulants of the data distribution. In some implementations, the SSM 112 can model (e.g., via regression analysis fitting) the raw data with various model distributions (normal distribution, log-normal distribution, binomial distribution, Poisson distribution, Gamma distribution, or any other distribution. In such implementations, the one or more parameters can include an identification of the fitting distribution being used together with the fitting parameters determined by the SSM 112. In some implementations, the SSM 112 can use multiple distributions to fit the raw data from one sensor, e.g., a main distribution and a tail distribution for outlier data points. The parameters of the distributions obtained by the SSM 112 can be sensor-specific. For example, for some sensors a small number of parameters can be determined (mean, median, variance) whereas for some sensor many more (e.g., 10 or 20) moments can be determined.

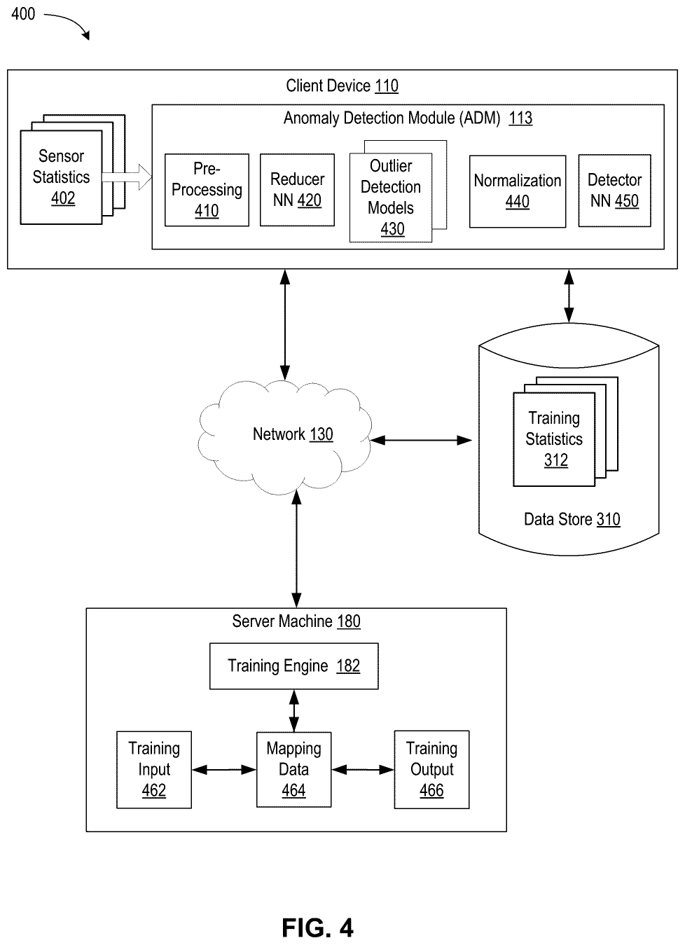

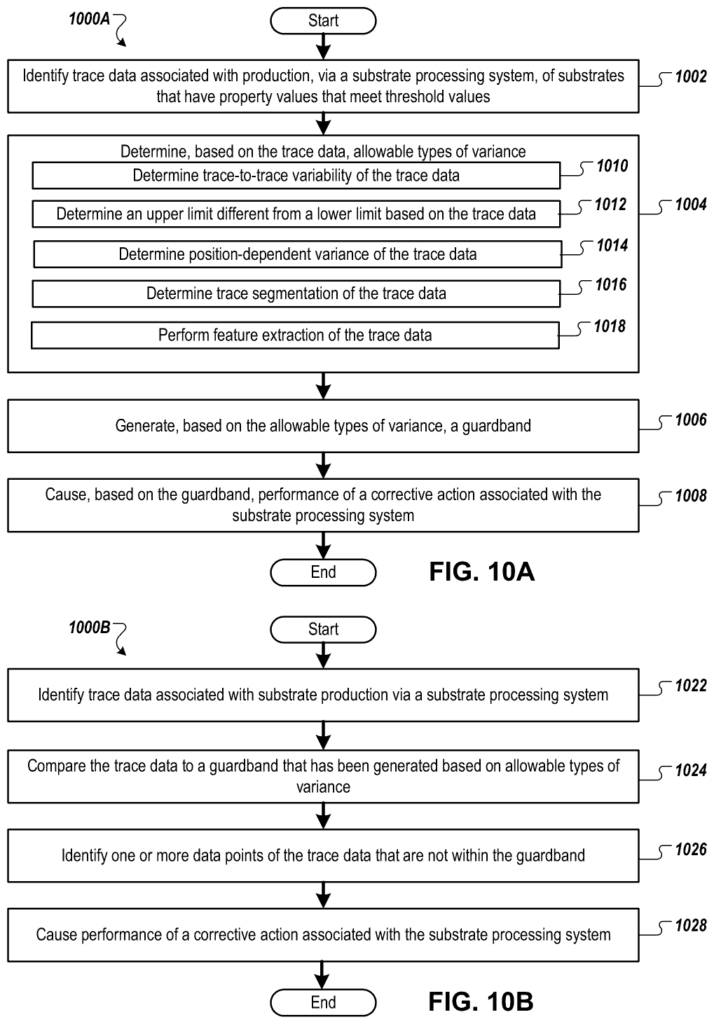

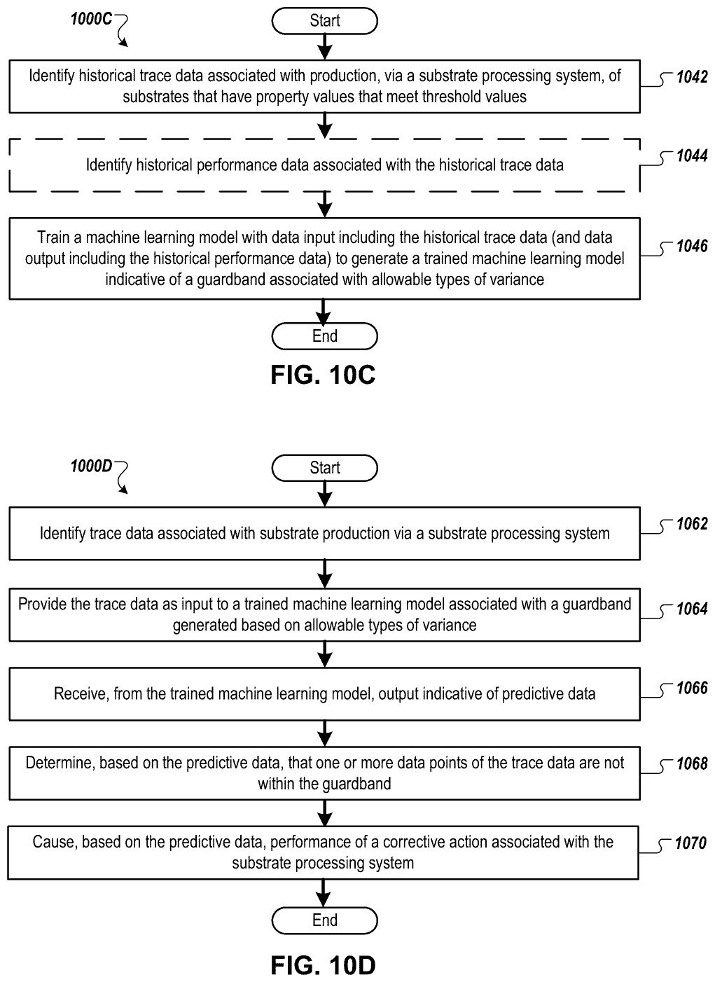

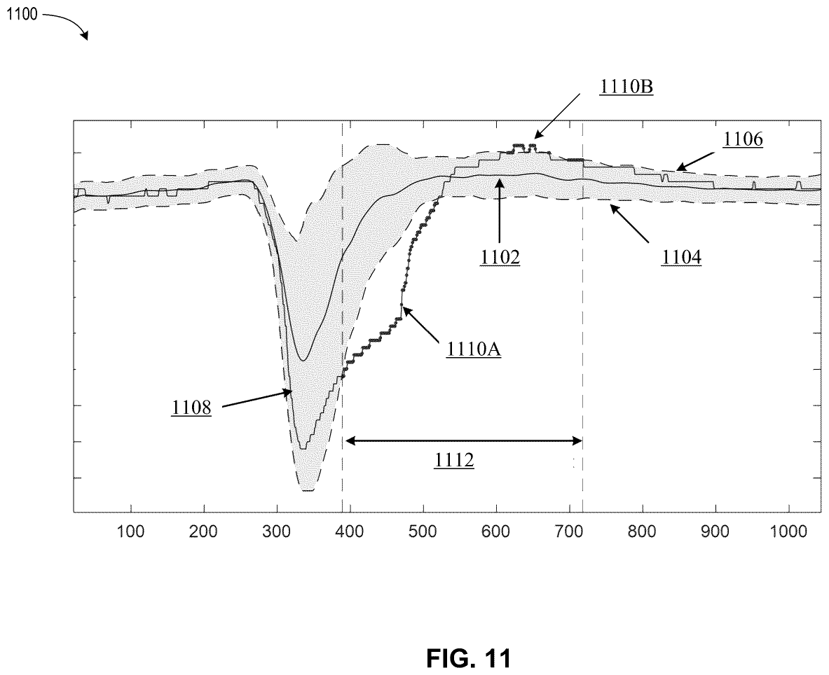

ADM 113 can process, aggregate, and analyze the statistics collected by the SSM 112. In some implementations, ADM 113 can pre-process, reduce the dimensionality of the sensor statistics, process the reduced representations of statistics by multiple anomaly detection models, normalize, and/or process using a detector neural network to determine one or more anomaly scores. At least some of the listed operations can include machine-learning. In some implementations, ADM 113 can one or more detection techniques, such as, for example, statistical anomaly detection techniques (e.g., Z-score, Tukey's range test, Grubb's test, etc.), ensemble techniques (e.g., the Anomaly Detection Ensemble (ADE) system, feature bagging techniques, score normalization techniques, etc.), fuzzy logic-based outlier detection techniques, Bayesian networks, hidden Markov models (HMMs), a Fourier transform method, a trace analysis method that generates adaptive “guardbands” on certain sensors (referred to as a “Guardband system”), an anomaly detection neural network (ADN), or any other type of anomaly detection techniques. One or more machine-learning models configured to perform operations related to one or more detection techniques of ADM 113 can be generated by the predictive system 160, which is discussed with regards to FIG. 3. In some implementations, predictive system 160 can generate different trained machine-learning models, each configured to perform multiple different types of detection techniques. An illustrative example for implementing ensemble techniques (e.g., an ADE system) and performing anomaly detection using the ensemble techniques is discussed with regards to FIGS. 4-9. An illustrative example for implementing a Guardband system and performing anomaly detection using the Guardband system is discussed with regards to FIGS. 10A-11.

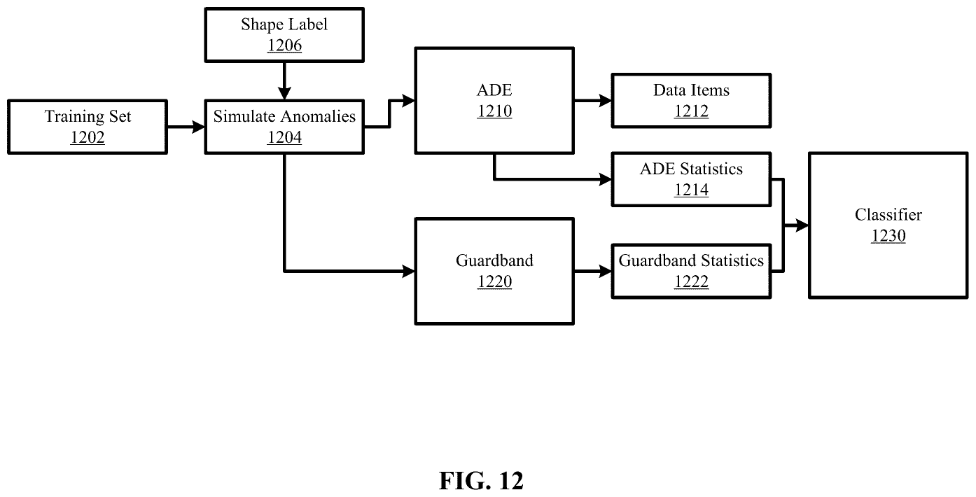

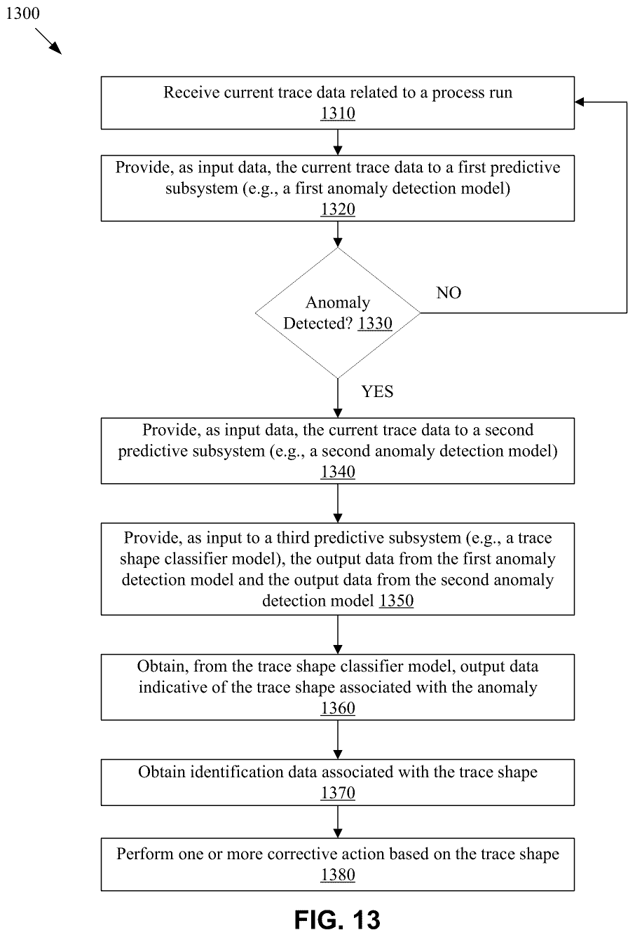

Classifier module 114 can process the data obtained from ADM 113 to identify and classify an anomalous trace data. In some implementations, the anomalous trace data can be reflected an anomalous trace shape. The anomalous trace shape can refer to one or more values (e.g., a vector, a scalar, an equation, an expression, etc.), one or more patterns, etc. that are associated with one or more issues or failures associated with a process chamber sub-system. More specifically, anomalous trace shape can refer to trace data that satisfies an anomaly threshold criterion (e.g., exceeds or falls below a specified value), trace data that is identified by ADM 113 as substantially (e.g., higher than a certain percentage, exceed a certain value, etc.) different than baseline or control data, that exceeds an established limit, etc. In some implementations, classifier module 114 can use one or more machine-learning models configured to perform operations related to identifying and classifying anomalous trace data, such as an anomalous trace shapes. These one or more machine-learning models (referred to as a trace shape classifier model) can be generated by the predictive system 160, which is discussed with regards to FIG. 3. An illustrative example for implementing and using the trace shape classifier model and is discussed with regards to FIGS. 12-13.

Corrective action module 115 can receive user input (e.g., via a Graphical User Interface (GUI) displayed via the client device 110) of an indication associated with manufacturing equipment 124. In some implementations, the corrective action module 115 receives input data from classifier module 114, determines a corrective action based on the input data, and causes the corrective action to be implemented. For example, responsive to receiving a classification of a trace shape, the correction action module 115 can perform one or more corrective action (e.g., increase power, decrease flowrate, etc.). In another example, responsive to receiving an indication sensor data (from the trace shape) satisfied a threshold criterion (e.g., exceeded or fell below a fault detection limit), the correction action module 115 can perform one or more corrective action. The corrective actions can be stored in an anomaly trace shapes library on data store 140. In some implementations, the corrective action module 115 receives an indication of a corrective action from the predictive system 160 and causes the corrective action to be implemented. Each client device 110 can include an operating system that allows users to one or more of generate, view, or edit data (e.g., indication associated with manufacturing equipment 124, corrective actions associated with manufacturing equipment 124, etc.).

Although shown as module of client device 110, each module 111-115 can be included in one or more other computing devices, such as a rackmount server, a router computer, a server computer, a personal computer, a mainframe computer, a laptop computer, a tablet computer, a desktop computer, a GPU, an ASIC, etc. Each module 111-115 can execute instructions to perform any one or more of the methodologies and/or implementations described herein. The instructions can be stored on a computer readable storage medium, which can include the main memory, static memory, secondary storage and/or processing device (during execution of the instructions).

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing a substrate at manufacturing equipment 124. For example, data store 140 can store data collected by sensors 126 at manufacturing equipment 124 before, during, or after a substrate process (referred to as process data). Process data can refer to historical process data (e.g., process data generated for a prior substrate processed at the manufacturing system) and/or current process data (e.g., process data generated for a current substrate processed at the manufacturing system). Data store can also store spectral data or non-spectral data associated with a portion of a substrate processed at manufacturing equipment 124. Spectral data can include historical spectral data and/or current spectral data.

Data store 140 can also store contextual data associated with one or more substrates processed at the manufacturing system. Contextual data can include a recipe name, recipe step number, preventive maintenance indicator, operator, etc. Contextual data can refer to historical contextual data (e.g., contextual data associated with a prior process performed for a prior substrate) and/or current process data (e.g., contextual data associated with current process or a future process to be performed for a prior substrate). The contextual data can further include identify sensors that are associated with a particular sub-system of a process chamber.

Data store 140 can also store task data. Task data can include one or more sets of operations to be performed for the substrate during a deposition process and can include one or more settings associated with each operation. For example, task data for a deposition process can include a temperature setting for a process chamber, a pressure setting for a process chamber, a flow rate setting for a precursor for a material of a film deposited on a substrate, etc. In another example, task data can include controlling pressure at a defined pressure point for the flow value. Task data can refer to historical task data (e.g., task data associated with a prior process performed for a prior substrate) and/or current task data (e.g., task data associated with current process or a future process to be performed for a substrate).

In some implementations, data store 140 can store statistics data. Statistics data can include statistics representative of the raw data, generated by SSM 112, e.g., mean data (average), range data, standard deviation data, maximum and minimum data, median data, mode data, etc. Mean data can include a measured averages of two or more values. For example, mean data can be used to determine the average heater temperature, the process chamber pressure, the average flowrate of a gas, etc., during a step(s), a specific time duration, an entire process recipe, etc. Range data can include the middle observation in a set of data (e.g., a median temperature during a step). Range data can include the difference between a maximum value and a minimum value of a set of values (e.g. the range of the heater pressure during a process recipe). The standard deviation is measure of the amount of variation or dispersion of a set of values.

In some implementations, data store 140 can be configured to store data that is not accessible to a user of the manufacturing system. For example, process data, spectral data, contextual data, etc. obtained for a substrate being processed at the manufacturing system is not accessible to a user (e.g., an operator) of the manufacturing system. In some implementations, all data stored at data store 140 can be inaccessible by the user of the manufacturing system. In other or similar implementations, a portion of data stored at data store 140 can be inaccessible by the user while another portion of data stored at data store 140 can be accessible by the user. In some implementations, one or more portions of data stored at data store 140 can be encrypted using an encryption mechanism that is unknown to the user (e.g., data is encrypted using a private encryption key). In other or similar implementations, data store 140 can include multiple data stores where data that is inaccessible to the user is stored in one or more first data stores and data that is accessible to the user is stored in one or more second data stores.

In some implementations, data store 140 can be configured to store identification data associated with anomalous trace data (e.g., anomalous trace shapes). The identification data can identify the type of (or behavior of) particular anomalous trace data. The identification data can be presented to the user (e.g., a display message indicative of the anomalous trace shape and/or the type of issue associated with particular anonymous trace data (e.g., an anomalous trace shape). For example, a shark fin trace shape can be indicative of electrical issues or timing issues, a spike trace shape can be indicative of erratic behavior by processing equipment, an offset trace shape can be indicative of a mismatch between the expected recipe values and the actual recipe values, etc. In some implementations, one or more anomalous trace shapes can be associated with a corrective action (e.g., an anomalous trace shape can be correlated to parameter adjustment steps to correct the issue or failure indicated by the anomalous trace shape). For example, the predictive system 160 or the corrective action module 115 can compare the trace shape of an identified anomaly to a library of known anomalous trace shapes to determine the type of failure experienced by a sub-system, the cause of the failure (e.g., a underlying issue that caused the anomalous trace data, such as, for example, a particular defective part, a heat leak, etc.), the recommended corrective action to correct the failure, fault, and/or cause, and so forth.

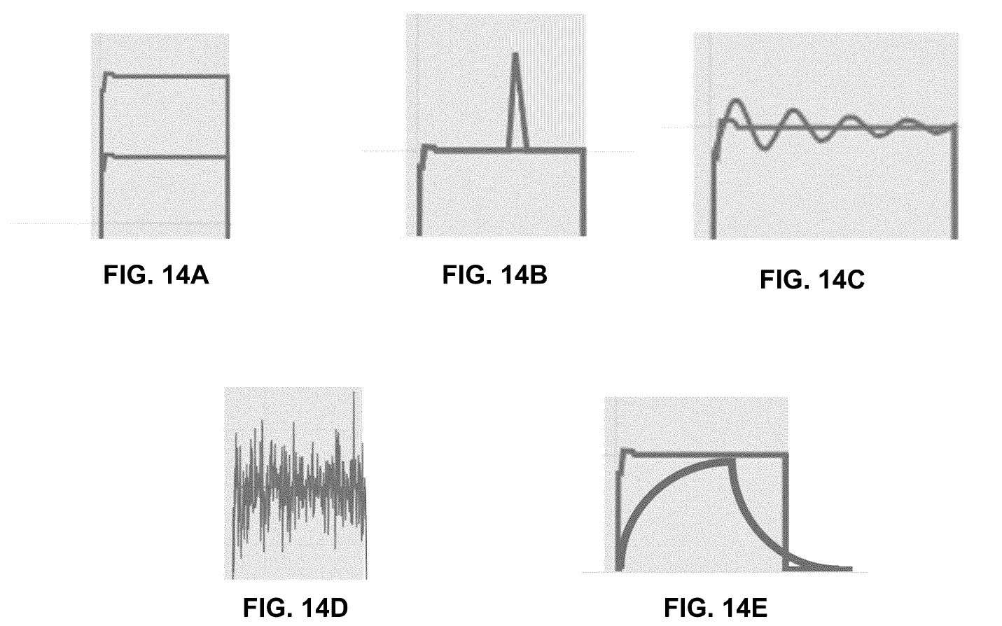

FIGS. 14A-14E illustrate a set of example anomalous trace shapes, in accordance with aspects of the present disclosure. In particular, FIG. 14A shows an offset trace shape where an anomalous trace shape is similar to the normal trace shape but offset by a certain factor. The offset trace shape can be indicative of a mismatch between the expected recipe values and the actual recipe values. For example, the offset trace shape can be indicative of a customer changing a recipe or values of a recipe, incorrect lookup table values used, etc. This can be corrected by, for example, adjusting the recipe values.

FIG. 14B shows a spike trace shape where an anomalous trace shape spikes in value as compared to the non-anonymous trace data. The spike trace shape can be indicative of erratic behavior cause by, for example, equipment problems. For example, the spike trace shape can be indicative a defective component of the manufacturing equipment causing an electrical arc, a plasma arc, a leak, etc. This can be corrected by, for example, replacing or fixing the defective component.

FIG. 14C shows an oscillation trace shape where an anomalous trace shape osculates when it's expected to be stable. The oscillation trace shape can be indicative of stability issues. For example, the oscillation trace shape can be indicative the manufacturing equipment having issues reaching a setpoint, a PID controller issue, etc. This can be corrected by, for example, calibrating a PID controller.

FIG. 14D shows a noise trace shape where an anomalous trace shape is similar to electrical noise. The noise trace shape can be indicative of connection issues (e.g., a component is poorly or improperly connected). This can be corrected by, for example, fixing a poor or improper connection.

FIG. 14E shows a shark fin trace shape where an anomalous trace shape is similar to a shark fin trace shape. The shark fin trace shape can be indicative of a delayed rise and/or fall in time. This can result from electrical issues, timing issues, etc. This can be corrected by, for example, adjusting or fixing the timing issues.

Returning to FIG. 1, the client device 110, manufacturing equipment 124, sensors 126, predictive system 160, and data store 140 can be coupled to each other via a network 130. In some implementations, network 130 is a public network that provides client device 110 with access to predictive system 160, data store 140, manufacturing equipment 124 and other publicly available computing devices. In some implementations, network 130 is a private network that provides client device 110 access to manufacturing equipment 124, data store 140, predictive system 160, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

In implementations, a “user” can be represented as a single individual. However, other implementations of the disclosure encompass a “user” being an entity controlled by a plurality of users and/or an automated source. For example, a set of individual users federated as a group of administrators can be considered a “user.”

FIG. 2 is a top schematic view of an example manufacturing system 200, according to aspects of the present disclosure. Manufacturing system 200 can perform one or more processes on a substrate 202. Substrate 202 can be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 200 can include a process tool 204 and a factory interface 206 coupled to process tool 204. Process tool 204 can include a housing 208 having a transfer chamber 210 therein. Transfer chamber 210 can include one or more process chambers (also referred to as processing chambers) 214, 216, 218 disposed therearound and coupled thereto. Process chambers 214, 216, 218 can be coupled to transfer chamber 210 through respective ports, such as slit valves or the like. Transfer chamber 210 can also include a transfer chamber robot 212 configured to transfer substrate 202 between process chambers 214, 216, 218, load lock 220, etc. Transfer chamber robot 212 can include one or multiple arms where each arm includes one or more end effectors at the end of each arm. The end effector can be configured to handle particular objects, such as wafers, sensor discs, sensor tools, etc.

Process chambers 214, 216, 218 can be adapted to carry out any number of processes on substrates 202. A same or different substrate process can take place in each processing chamber 214, 216, 218. A substrate process can include atomic layer deposition (ALD), physical vapor deposition (PVD), chemical vapor deposition (CVD), etching, annealing, curing, pre-cleaning, metal or metal oxide removal, or the like. Other processes can be carried out on substrates therein. Process chambers 214, 216, 218 can each include one or more sensors configured to capture data for substrate 202 before, after, or during a substrate process. For example, the one or more sensors can be configured to capture spectral data and/or non-spectral data for a portion of substrate 202 during a substrate process. In other or similar implementations, the one or more sensors can be configured to capture data associated with the environment within process chamber 214, 216, 218 before, after, or during the substrate process. For example, the one or more sensors can be configured to capture data associated with a temperature, a pressure, a gas concentration, etc. of the environment within process chamber 214, 216, 218 during the substrate process.

In some implementations, metrology equipment (not shown) can be located within the process tool. In other implementations, metrology equipment (not shown) can be located within one or more process chambers 214, 216, 218. In some implementations, the substrate can be placed onto metrology equipment using transfer chamber robot 212. In other implementations, the metrology equipment can be part of the substrate support assembly (not shown). Metrology equipment can provide metrology data associated with substrates processed by manufacturing equipment 124. The metrology data can include a value of film property data (e.g., wafer spatial film properties), dimensions (e.g., thickness, height, etc.), dielectric constant, dopant concentration, density, defects, etc. In some implementations, the metrology data can further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, TEM techniques, and so forth.

A load lock 220 can also be coupled to housing 208 and transfer chamber 210. Load lock 220 can be configured to interface with, and be coupled to, transfer chamber 210 on one side and factory interface 206. Load lock 220 can have an environmentally-controlled atmosphere that can be changed from a vacuum environment (wherein substrates can be transferred to and from transfer chamber 210) to an at or near atmospheric-pressure inert-gas environment (wherein substrates can be transferred to and from factory interface 206) in some implementations. Factory interface 206 can be any suitable enclosure, such as, e.g., an Equipment Front End Module (EFEM). Factory interface 206 can be configured to receive substrates 202 from substrate carriers 222 (e.g., Front Opening Unified Pods (FOUPs)) docked at various load ports 224 of factory interface 206. A factory interface robot 226 (shown dotted) can be configured to transfer substrates 202 between carriers (also referred to as containers) 222 and load lock 220. Carriers 222 can be a substrate storage carrier or a replacement part storage carrier.

Manufacturing system 200 can also be connected to a client device (e.g., client device 110, not shown) that is configured to provide information regarding manufacturing system 200 to a user (e.g., an operator). In some implementations, the client device can provide information to a user of manufacturing system 200 via one or more graphical user interfaces (GUIs). For example, the client device can provide information regarding a target thickness profile for a film to be deposited on a surface of a substrate 202 during a deposition process performed at a process chamber 214, 216, 218 via a GUI. The client device can also provide information regarding anomaly detection and trace shape classification, in accordance with implementations described herein.

Manufacturing system 200 can also include a system controller 228. System controller 228 can be and/or include a computing device such as a personal computer, a server computer, a programmable logic controller (PLC), a microcontroller, and so on. System controller 228 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 228 can include a data storage device (e.g., one or more disk drives and/or solid state drives), a main memory, a static memory, a network interface, and/or other components. System controller 228 can execute instructions to perform any one or more of the methodologies and/or implementations described herein. In some implementations, system controller 228 can execute instructions to perform one or more operations at manufacturing system 200 in accordance with a process recipe. The instructions can be stored on a computer readable storage medium, which can include the main memory, static memory, secondary storage and/or processing device (during execution of the instructions).

System controller 228 can receive data from sensors (e.g., sensors 126, now shown) included on or within various portions of manufacturing system 200 (e.g., processing chambers 214, 216, 218, transfer chamber 210, load lock 220, etc.). In some implementations, data received by the system controller 228 can include spectral data and/or non-spectral data for a portion of substrate 202. In other or similar implementations, data received by the system controller 228 can include data associated with processing substrate 202 at processing chamber 214, 216, 218, as described previously. For purposes of the present description, system controller 228 is described as receiving data from sensors included within process chambers 214, 216, 218. However, system controller 228 can receive data from any portion of manufacturing system 200 and can use data received from the portion in accordance with implementations described herein. In an illustrative example, system controller 228 can receive data from one or more sensors for process chamber 214, 216, 218 before, after, or during a substrate process at the process chamber 214, 216, 218. Data received from sensors of the various portions of manufacturing system 200 can be stored in a data store 250. Data store 250 can be included as a component within system controller 228 or can be a separate component from system controller 228. In some implementations, data store 250 can be data store 140 described with respect to FIG. 1.

FIG. 3 depicts an illustrative predictive architecture 300, according to aspects of the present disclosure. In some implementations, predictive architecture 300 include predictive system 160, network 130, and data store 310 (which can be similar to the same as data store 140). In some implementations, predictive system 160 can use a model (e.g., model 190) to identify and/or classify a trace data (e.g., a trace shape). In some implementations, predictive system 160 can use a model (e.g., model 190) to detect an anomaly. Multiple models can be generated (e.g., trained) and configured for use by ADM 113 and/or classifier module 114. In some implementations, each model 190 can be referred to as a “predictive subsystem”). In some implementations, predictive system 160 can include predictive server 112, server machines 170 and 180, and predictive server 195. The predictive server 160, server machine 170, server machine 180, and predictive server 195 can each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

Server machine 170 includes a training set generator 172 that is capable of generating training data sets (e.g., a set of data inputs and a set of target outputs) to train, validate, and/or test a machine-learning model 190. Machine-learning model 190 can be any algorithmic model capable of learning from data. In some implementations, machine-learning model 190 can be a predictive model. In some implementations, the data set generator 172 can partition the training data into a training set, a validating set, and a testing set, which can be stored, as part of the training statistics 312, in the training data store 310. Training statistics 312 which can be accessible to the computing device predictive system 160 directly or via network 130. In some implementations, the predictive system 160 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. Training engine 182 can be capable of training one or more machine-learning model 190. Machine-learning model 190 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine-learning model 190 that captures these patterns. The machine-learning model 190 can use one or more of a statistical modelling, support vector machine (SVM), Radial Basis Function (RBF), clustering, supervised machine-learning, semi-supervised machine-learning, unsupervised machine-learning, k-nearest neighbor algorithm (k-NN), linear regression, random forest, neural network (e.g., artificial neural network), etc.

One type of machine-learning model that can be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). Deep learning is a class of machine-learning algorithms that use a cascade of multiple layers of nonlinear processing units for feature extraction and transformation. Each successive layer uses the output from the previous layer as input. Deep neural networks can learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In a plasma process tuning, for example, the raw input can be process result profiles (e.g., thickness profiles indicative of one or more thickness values across a surface of a substrate); the second layer can compose feature data associated with a status of one or more zones of controlled elements of a plasma process system (e.g., orientation of zones, plasma exposure duration, etc.); the third layer can include a starting recipe (e.g., a recipe used as a starting point for determining an updated process recipe the process a substrate to generate a process result the meets threshold criteria). Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs can be that of the network and can be the number of hidden layers plus one. For recurrent neural networks, in which a signal can propagate through a layer more than once, the CAP depth is potentially unlimited.

In one implementation, one or more machine-learning model is a recurrent neural network (RNN). An RNN is a type of neural network that includes a memory to enable the neural network to capture temporal dependencies. An RNN is able to learn input-output mappings that depend on both a current input and past inputs. The RNN will address past and future flow rate measurements and make predictions based on this continuous metrology information. RNNs can be trained using a training dataset to generate a fixed number of outputs (e.g., to determine a set of substrate processing rates, determine modification to a substrate process recipe). One type of RNN that can be used is a long short term memory (LSTM) neural network.

Training of a neural network can be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

A training dataset containing hundreds, thousands, tens of thousands, hundreds of thousands or more sensor data and/or process result data (e.g., metrology data such as one or more thickness profiles associated with the sensor data) can be used to form a training dataset.

To effectuate training, processing logic can input the training dataset(s) into one or more untrained machine-learning models. Prior to inputting a first input into a machine-learning model, the machine-learning model can be initialized. Processing logic trains the untrained machine-learning model(s) based on the training dataset(s) to generate one or more trained machine-learning models that perform various operations as set forth above. Training can be performed by inputting one or more of the sensor data into the machine-learning model one at a time.

The machine-learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine-learning model can produce.

Accordingly, the output can include one or more predictions or inferences. In some implementations, an output prediction or inference can include one or more predictions relating to anomaly detection, trace shape classification, etc. In some implementations, an output prediction or inference can include one or more predictions of anomaly data, fault data, fault detection limits, trace shape classifiers, etc. Processing logic determines an error (i.e., a classification error) based on the differences between the output (e.g., predictions or inferences) of the machine-learning model and target labels associated with the input training data. Processing logic adjusts weights of one or more nodes in the machine-learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In one implementation, the stopping criteria is met when at least a minimum number of data points have been processed and at least a threshold accuracy is achieved. The threshold accuracy can be, for example, 70%, 80% or 90% accuracy. In one implementation, the stopping criterion is met if accuracy of the machine-learning model has stopped improving. If the stopping criterion has not been met, further training is performed. If the stopping criterion has been met, training can be complete. Once the machine-learning model is trained, a reserved portion of the training dataset can be used to test the model.

Once one or more trained machine-learning models 190 are generated, they can be stored in predictive server 195 as predictive component 197 or as a component of predictive component 197.

The validation engine 184 can be capable of validating machine-learning model 190 using a corresponding set of features of a validation set from training set generator 172. Once the model parameters have been optimized, model validation can be performed to determine whether the model has improved and to determine a current accuracy of the deep learning model. The validation engine 184 can determine an accuracy of machine-learning model 190 based on the corresponding sets of features of the validation set. The validation engine 184 can discard a trained machine-learning model 190 that has an accuracy that does not meet a threshold accuracy. In some implementations, the selection engine 185 can be capable of selecting a trained machine-learning model 190 that has an accuracy that meets a threshold accuracy. In some implementations, the selection engine 185 can be capable of selecting the trained machine-learning model 190 that has the highest accuracy of the trained machine-learning models 190.

The testing engine 186 can be capable of testing a trained machine-learning model 190 using a corresponding set of features of a testing set from data set generator 172. For example, a first trained machine-learning model 190 that was trained using a first set of features of the training set can be tested using the first set of features of the testing set. The testing engine 186 can determine a trained machine-learning model 190 that has the highest accuracy of all of the trained machine-learning models based on the testing sets.

As described in detail below, predictive server 195 includes a predictive component 197 that is capable of providing data indicative of sensor groupings or rankings, and running trained machine-learning model 190 on data items such as sensor data, statistics data, etc. input to obtain one or more outputs. The predictive server 195 can further provide fault detection data, anomaly detection data, trace shape classification data, etc. This will be explained in further detail below.

It should be noted that in some other implementations, the functions of server machines 170 and 180, as well as predictive server 195, can be provided by a fewer number of machines. For example, in some implementations, server machines 170 and 180 can be integrated into a single machine, while in some other or similar implementations, server machines 170 and 180, as well as predictive server 195, can be integrated into a single machine.

In general, functions described in one implementation as being performed by server machine 170, server machine 180, and/or predictive server 195 can also be performed on client device 110. In addition, the functionality attributed to a particular component can be performed by different or multiple components operating together.

In some implementations, a manufacturing system can include more than one process chambers. For example, example manufacturing system 200 of FIG. 2 illustrates multiple process chambers 214, 216, 218. It should be noted that, in some implementations, data obtained to train the machine-learning model 190 and data collected to be provided as input to the machine-learning model can be associated with the same process chamber of the manufacturing system. In other or similar implementations, data obtained to train the machine-learning model and data collected to be provided as input to the machine-learning model can be associated with different process chambers of the manufacturing system. In other or similar implementations, data obtained to train the machine-learning model can be associated with a process chamber of a first manufacturing system and data collected to be provide as input to the machine-learning model can be associated with a process chamber of a second manufacturing system.

FIG. 4 is an exemplary illustration of a machine-learning system 400 that is capable of anomaly detection based on sensor data or statistics using neural networks, in accordance with some implementations of the present disclosure. As illustrated, the machine-learning system 400 can include a client device 110, a training statistics repository, such as data store 310, and server machine 180 connected to network 130. Network 130 can be a public network (e.g., the Internet), a private network (e.g., a local area network (LAN) or wide area network (WAN)), or a combination thereof. Depicted in FIG. 4 is a set of sensor statistics 402 (which can be generated by SSM 112 based on raw data obtained by the SCM 111 from sensors 126) that can be processed by the ADM 113. The ADM 113 can include a number of components (implemented in software and hardware), such as pre-processing module 410, reducer neural network 420, one or more outlier detection models 430, normalization module 440, detector neural network 450, and other components not depicted explicitly in FIG. 4.

The pre-processing module 410 can remove artifacts that can be associated with preventive maintenance, intended changes in the settings of the manufacturing processes, changes in the settings of the system hardware, and the like, to produce the initial representation of sensor statistics. The initial representation of sensor statistics can be aggregated statistics for some or all the sensor data. The reducer neural network 420 (herein referred to as simply the “reducer 420”) can reduce the statistics prepared by the pre-processing 410 and transform the initial representation of the statistics to a different representation (referred herein as the reduced representation) that includes the most representative features of the statistics and has fewer elements (e.g., parameters) than the initial representation. The outlier detection models 430 can identify various (statistical) features present in the reduced representation of statistics. The identified statistical features can be cast in the form of outlier scores amenable to neural network processing. The normalization module 440 can normalize the inhomogeneous outputs (outlier scores) of various detection models to prepare the outputs for the neural network processing. The detector neural network 450 (herein sometimes referred to as the “detector 450”) can use the normalized features output by the outlier detection models 430 and predict the anomaly score for the manufacturing process.

The reducer 420 and/or the detector 450 can be trained by the server machine 180, which can include training engine 182. The training engine 182 can construct the machine-learning models (e.g., neural networks 420 and 450), in some implementations. The neural networks 420 and 450 can be trained by the training engine 182 using training data that includes training inputs 462 and corresponding training (target) outputs 466. In some implementations, the reducer 420 and the detector 450 can be trained separately.

The training outputs 466 can include correct associations (mappings) of training inputs 462 to training outputs 466. The training engine 182 can find patterns in the training data that map the training input 462 to the training output 466 (e.g., the associations to be predicted), and train the reducer 420 and/or detector 450 to capture these patterns. The patterns can subsequently be used by the reducer 420 and/or detector 450 for future data processing and anomaly detection. For example, upon receiving a set of sensor statistics 402, the trained reducer 420 and/or detector 450 can be capable of identifying if the sensor statistics 402 are indicative of a manufacturing anomaly, such as one or more operations or products of the manufacturing equipment 124 deviating from the respective process recipes or product specifications.

Each of the neural networks 420 and 450 can include a single level of linear or non-linear neural operations, in various implementations. In some implementations, the neural networks 420 and 450 can be deep neural networks having multiple levels of linear or non-linear operations. Examples of deep neural networks are neural networks including convolutional neural networks, recurrent neural networks (RNN) with one or more hidden layers, fully connected neural networks, Boltzmann machines, and so on. In some implementations, the neural networks 420 and 450 can include multiple neurons wherein each neuron can receive its input from other neurons or from an external source and can produce an output by applying an activation function to the sum of weighted inputs and a trainable bias value. The neural networks 420 and 450 can include multiple neurons arranged in layers, including an input layer, one or more hidden layers, and an output layer. Neurons from adjacent layers can be connected by weighted edges. Initially, all the edge weights can be assigned some starting (e.g., random) values. For every training input 462 in the training dataset, the training engine 182 can cause the neural networks 420 and 450 to generate outputs (predicted anomaly scores for a set of training sensor statistics). The training engine 462 can compare the observed output of the neural networks 420 and 450 with the target training output 466. The resulting error, e.g., the difference between the target training output and the actual output of the neural networks, can be propagated back through the neural networks 420 and 450, and the weights and biases in the neural networks can be adjusted to make the actual outputs closer to the training outputs. This adjustment can be repeated until the output error for a particular training input 462 satisfies a predetermined condition (e.g., falls below a predetermined value). Subsequently, a different training input 462 can be selected, a new output generated, a new series of adjustments implemented, until the neural networks are trained to an acceptable degree of accuracy.

The training inputs 462, the training outputs 466, and the mapping data 464 can be stored, as part of the training statistics 312, in the data store 310, which can be accessible to the client device 110 directly or via network 130. The training statistics 312 can be actual, e.g., past statistics of sensors 126 of the manufacturing equipment 124 or a similar type of machine (e.g., one or more machine used by a developer to train the neural networks 420 and 450). The training statistics 312 can include a wide variety of statistics representative of an occurrence (or non-occurrence) of a particular manufacturing anomaly, such as incorrect temperature, pressure, chemical compositions regimes, deficient (or normal) film, wafer, or any other product of the manufacturing equipment 124 (or a similar machine). The training statistics 312 can include examples of anomalies present in the manufacturing process to various degrees, such as a significant anomaly that results in a sub-standard yield, a correctable anomaly that can be eliminated with timely and appropriate counter-measures, an insignificant anomaly that is unlikely to affect the quality of the manufacturing output, and so on. In some implementations, the presence of the anomaly in the training statistics 312 can be indicated by a continuous or quasi-continuous anomaly score (e.g., a value within the 0.0 to 1.0 range, or 0 to 100 range, or any other range). Anomaly score in the training statistics 312 can be a part of the training output 466.

The data store 310 can be a persistent storage capable of storing sensor data or sensor data statistics as well as metadata for the stored data/statistics. The data store 310 can be hosted by one or more storage devices, such as main memory, magnetic or optical storage-based disks, tapes or hard drives, NAS, SAN, and so forth. Although depicted as separate from the client device 110, in some implementations the data store 310 can be a part of the client device 110. In some implementations, the data store 310 can be a network-attached file server, while in other implementations the data store 310 can be some other type of persistent storage, such as an object-oriented database, a relational database, and so forth, that can be hosted by a server machine, or one or more different machines coupled to the client device 110 via the network 130.

Once the neural networks 420 and 450 are trained, the trained neural networks can be provided to the ADM 113 for processing of new sensor data or statistics. For example, the ADM 113 can receive a new set of sensor statistics 402, pass it through some or all of the components of the ADM 113, e.g., pre-processing 410, reducer 420, one or more outlier detection models 430, normalization module 440, and detector network 450 to predict an anomaly score representative of a likelihood that the sensor statistics 402 is indicative of a manufacturing anomaly.

“Processing device” herein refers to a device capable of executing instructions encoding arithmetic, logical, or I/O operations. In one illustrative example, a processing device can follow Von Neumann architectural model and can include an arithmetic logic unit (ALU), a control unit, and a plurality of registers. In a further aspect, a processing device can be a single core processor, which is typically capable of executing one instruction at a time (or process a single pipeline of instructions), or a multi-core processor which can simultaneously execute multiple instructions. In another aspect, a processing device can be implemented as a single integrated circuit, two or more integrated circuits, or can be a component of a multi-chip module. A processing device can also be referred to as a CPU. “Memory device” herein refers to a volatile or non-volatile memory, such as random-access memory (RAM), read-only memory (ROM), electrically erasable programmable read-only memory (EEPROM), or any other device capable of storing data.

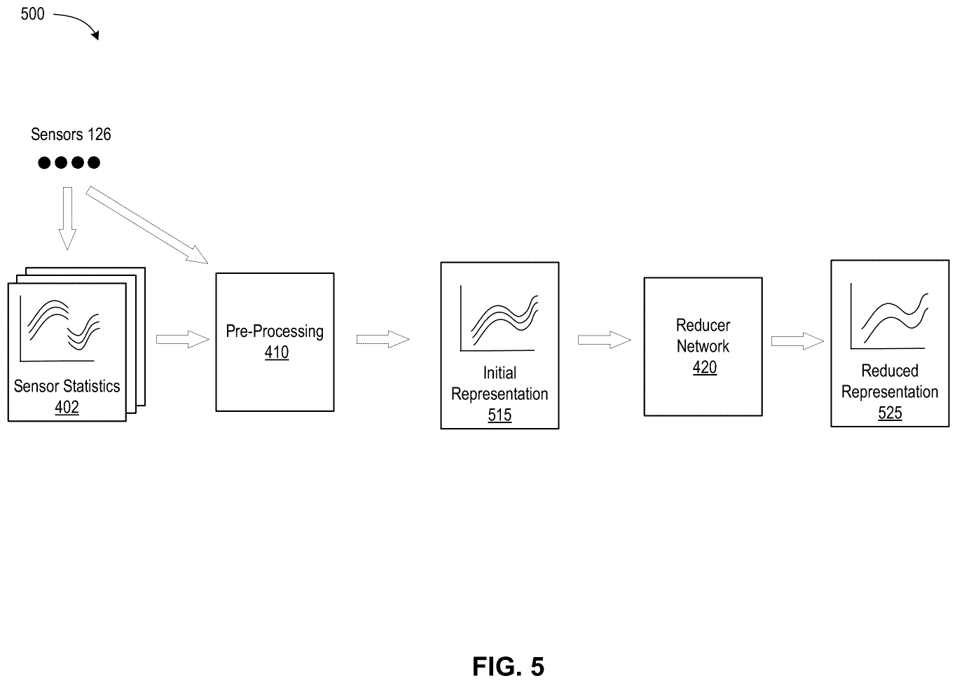

FIG. 5 is an exemplary illustration of a reduction stage 500 of anomaly detection based on aggregate statistics using neural networks, in accordance with some implementations of the present disclosure. Depicted in FIG. 5 is a set of sensor statistics 402 which can be derived from sensors 126 via one or more intermediate operations. For example, the SCM 111 can identify a time horizon (e.g., 30 seconds, three minutes, etc.), which can be a full duration of a particular (e.g., ongoing or about to start) manufacturing operation or a selected time interval that is less (or more) than the full duration of the operation. The SCM 111 can further identify which sensors 126 can be activated (or sampled) for the anomaly detection during the current operation for the duration of the identified time horizon. The SCM 111 can collect M sets of data (e.g., data from M sensors) each set including N readings. The number of readings, which can be controlled by varying a data sampling rate, can be sensor-specific. In some implementations, the time horizon can also be sensor-specific, so that sensor 1 can provide N₁ readings over time T₁ whereas sensor 2 can provide N₂ readings over time T₂. Accordingly, the SCM 111 can collect multiple sets of data points {Rⱼ}, wherein index j denotes a set of data points for the j-th sensor 1≤j≤M. Each set of data points can include a time series, {Rⱼ}=Rⱼ(t₁), Rⱼ(t₂), . . . . Rⱼ(t_{N}), of data readings. Based on the raw sensor data sampled by the SCM 111, the SSM 112 can conduct statistical analysis of each of the obtained datasets {Rⱼ}, to determine a set of statistical parameters {Pⱼ}=Pⱼ(1), Pⱼ (2), . . . . Pⱼ(S) that describe the respective dataset. The set of statistical parameters is referred to as “sensor statistics” (e.g., sensor statistics 402) in the instant disclosure. For example, Pⱼ(1) can be a mean value of the j-th dataset, Pⱼ(2) can be a median value of the same dataset, Pⱼ(3) can be a mode, Pⱼ(4) can be a standard deviation, Pⱼ(4) can be a half-width, Pⱼ(5) can be a lower bound (minimum value), Pⱼ(6) can be an upper bound (maximum value), Pⱼ(7) can be a skewness, Pⱼ(8) can be a kurtosis, and so on.

The sensor statistics 402 (e.g., sets of parameters {Pⱼ}) can be input into the pre-processing module 410, to filter out or otherwise account for various artifacts in the sensor data. In some implementations, the raw data (e.g., datasets {Rⱼ}) from sensors 126 can also be provided to the pre-processing module 410. Some of the features of the sensor statistics 402 can be representative of the anomalies of the manufacturing process, which are intended to be detected. Some of the features of the sensor statistics 402, however, can be indicative of various events that are not representative of any actual problems or deficiencies of the manufacturing processes, but could otherwise be detected as problematic, if the existence of such events is not properly taken into account. For example, the manufacturing equipment 124 might have undergone a maintenance (preventive, scheduled, or unplanned) procedure. During the maintenance procedure, one or more sensors 126 might have been exposed to a changed environment. Because sensors 126 are often miniature devices, the settings of the sensors (e.g., zero points) can change, as a result of such exposure. The sensor data can, therefore, shift substantially but such shifts cannot be representative of any manufacturing process anomalies. In some implementations, the shifts in the sensor statistics 402 can be indicative of intentional changes to the manufacturing process. For example, an operator (e.g., user) of the manufacturing equipment 124 can change a set point of one or more conditions inside the processing chamber 214, 216, 218, such as a change in temperature, gas flow rate, chemical composition or concentration of the gas delivered into the processing chamber 214, 216, 218. In some implementations, a change in the sensor statistics 402 can be triggered by a change in the settings of one or more hardware devices in the processing chamber, such as a replacement of a process kit (e.g., an edge ring or the like).

In such instances, the client device 110 can detect an occurrence of an artifact event (maintenance, change in process set points, changes in the hardware settings, etc.) and notify the SCM 111 about the event. The SSM 112 can receive an indication of the event (e.g., a robot blade removing an old edge ring and delivering a new edge ring (at a specified time) into the processing chamber 214, 216, 218. The SSM 112 can correlated the changes in the sensor statistics 402 in the time interval following the artifact event and adjust the statistics 202 to remove (or compensate for) the changes in the sensor statistics caused by the artifact event. For example, the SSM 112 can determine a new mean of the distribution of the affected sensors (which could be any sensors whose readings have shifted at or after the artifact event) and recalculate the sensor statistics based on the new mean. In some implementations, the pre-processing module 410 can remove outliers, invalid values (such as Not-a-Number values) or, conversely, impute (add) missing values. The sensor statistics corrected in the described (or a similar) way can be output by the pre-processing module 410 in the form of the sets of adjusted parameters {Pⱼ} reflecting the corrected (adjusted to compensate for the influence of the artifact events) sensor statistics 402. The adjusted parameters {Pⱼ} can constitute a representation of the sensor statistics that is referred to in the instant disclosure as the initial representation 515 of the sensor statistics (even though the representation 515 cannot be the earliest representation of the statistics generated by the SSM 112).

The initial representation 515 can be aggregated across some or all of the sensor statistics. Because different sensors statistics can be related to different quantities, including quantities measured in different units (e.g., temperature, pressure, gas flow, wafer thickness, reflectivity of the wafer surface, etc.), the sensor statistics can be normalized prior to aggregation. For example, the variance can first be expressed in units of the mean value squared whereas the third moment or cumulant (e.g., skewness) can be expressed in units of the mean cubed, and so on.

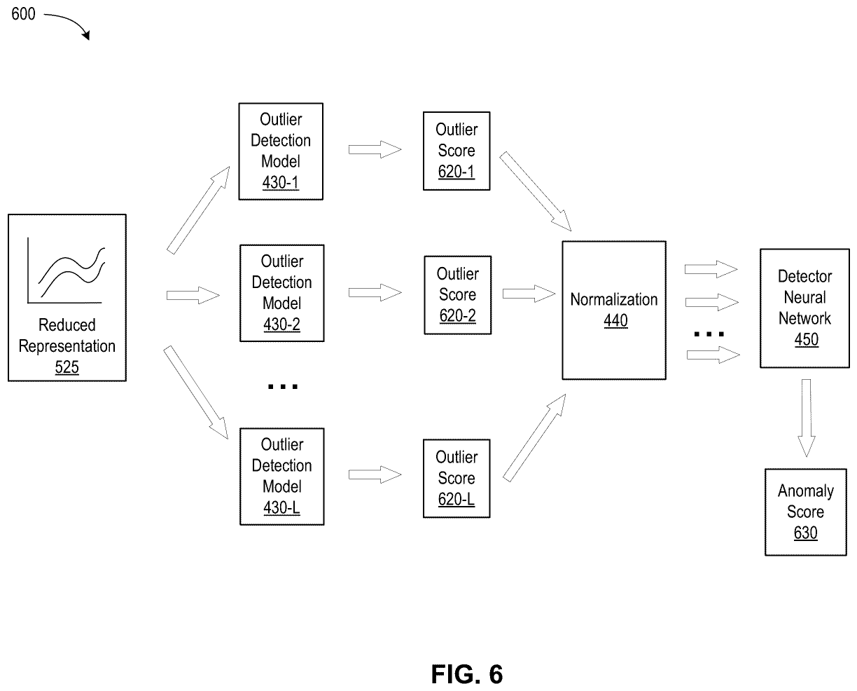

In some implementations, the initial representation 515 can be processed by the reducer neural network 420 to obtain a reduced representation 525 of the sensor statistics. The input to the reducer 420 can be an aggregated set of initial representations 515 of the sensor statistics. The initial representations 515 can contain a large amount of information only a fraction of which can be representative of a manufacturing anomaly. Accordingly, the function of the reducer 420 can be two-fold: to improve signal-to-noise ratio by distilling the initial representation 515 to the most representative features of the data statistics and to reduce the number of parameters describing the sensor statistics to a set that is more manageable and more amenable to further processing. The reducer neural network 420 can be an auto-encoder, in one implementation. In another implementation, the reducer neural network 420 can be an extreme learning machine. The reducer neural network 420 can be trained to output a reduced representation 525 having a number of dimensions that is lower (in some implementations, significantly lower) than the initial representation. For example, the reducer neural network 420 can use one of algorithms based on the Principal Component Analysis (PCA) to identify the most significant and representative (for the subsequent anomaly detection) features of the initial representation. In particular, PCA algorithms can find a transformation of the coordinate space of the initial representation 515 along which the variance of data points is maximized (principal axes) and select a certain number (determined and optimized during training) of the maximum variance axes, e.g., D. For each of the axes, the output can include one or more statistical parameters (mean, variance, etc.) for each of the principal axes, and a number of covariance parameters characterizing cross-correlations among statistical parameters relating to various axes. The advantage of using the reducer neural network 420 is that it allows to reduce the number of sensor statistics from, potentially, thousands of parameters to only a few (e.g., five, ten, twenty, and so on) key components, which represent critical variation of the sensor data and, at the same, time reduce noise. The use of the reducer 420 increase efficacy of the subsequent anomaly detection algorithms (as described in relation to FIG. 6). In some implementations, the reducer 420 can process all or some initial representations 515 of the sensor statistics concurrently.

FIG. 6 is an exemplary illustration of a detection stage 600 of anomaly detection based on aggregate statistics using neural networks, in accordance with some implementations of the present disclosure. Depicted in FIG. 6 is the reduced representation 525 of the sensor statistics being input into a set of the outlier detection models 430 (e.g., models 430-1, 430-2 . . . 430-L). Some or all of the outlier detection models 430 can employ a variety of algorithms, such as k-nearest neighbor outlier detection algorithms, clustering-based algorithms, mixture-based algorithms (e.g., a Cluster-Based Local Outlier Factor algorithm), embedding-based algorithms, decision-tree algorithms, support vector machine-based algorithms, histogram-based outlier score algorithms, principle component analysis algorithms, local outlier factor algorithms, local distance-based outlier detection algorithms, local outlier integral algorithms, and the like.

Each of the outlier detection models 430 applied to the reduced representation 525 can output a respective outlier score 620 indicative of the presence of various anomalies in the sensor statistics, according to the criteria of the respective outlier detection model 430. The outlier scores 620, being determined by different algorithms, can have values that are difficult to compare to each other directly. To make the outlier scores 620 better suited for subsequent uniform processing, the outlier scores 620 can be normalized by the normalization module 440. In some implementations, the normalization module 440 can perform a rescaling of the outlier scores 620. For example, if the maximum outlier value (e.g., a maximum value for a set of training sensor statistics, or a set of the actual run-time sensor statistics, or a combination thereof) is Oₘₐₓ and the minimum outlier value is Oₘᵢₙ, the normalized outlier score can be determined as:

$${O}_{norm} = \frac{O - {O}_{min}}{{O}_{max} - {O}_{min}} .$$

The uniform normalization brings all outlier scores to within the interval of values [0,1], but does not account for the fact that the outlier scores O can be distributed non-uniformly within the interval [Oₘᵢₙ, Oₘₐₓ]. In some implementations, it can be difficult to predict what minimum or maximum outlier scores can be encountered in actual processing, so that other methods, e.g., as described below, can be used instead.

Accordingly, in some implementations, the normalization can instead be performed using an assumption (an approximation or a hypothesis) of some underlying distribution of the outlier scores O. For example, accounting for a Gaussian distribution of the outlier scores can be performed by determining the normalized outlier score according to the formula:

$${O}_{norm} = max \{ 0 , Erf ( \frac{O - {O}_{mean}}{σ √ 2} ) \} ,$$

where Oₘₑₐₙ is the mean outlier score and σ is the standard deviation for the outlier scores (e.g., the mean value for a set of training sensor statistics, or a set of the actual sensor statistics, or a combination thereof), and Erf is the Gauss error function.

In some implementations, the normalization can be performed using the assumption of a Gamma distribution of the outlier scores according to the following formula:

$${O}_{norm} = max \{ 0 , \frac{F ( O ) - F ( {O}_{mean} )}{1 - F ( {O}_{mean} )} \} ,$$

where F(O) is the cumulative distribution function for the Gamma distribution, e.g.,

$$F ( O ) = \frac{γ ( \frac{{O}_{mean}^{2}}{{σ}^{2}} , O \cdot \frac{{O}_{mean}^{2}}{{σ}^{2}} )}{Γ ( \frac{{O}_{mean}^{2}}{{σ}^{2}} )} ,$$

with Γ(x) being the Gamma function and γ(x, y) being the incomplete Gamma function.

The above non-limiting examples are intended as illustrations only. In various implementations, different underlying distributions can be used and the respective distribution-based normalization schemes can be different. In some implementations, a mixture of two or more probability distributions can be used to normalize the outlier scores 420.

The normalized outlier scores Oₙₒᵣₘ₋₁, Oₙₒᵣₘ₋₂> . . . . O_{norm-L} obtained from all (or some of) the L outlier detection models 430 can be used as an input into the neural network detector 450 (“detector”) to determine the anomaly score. The detector 450 can be trained on a variety of training sensor statistics 310 using methods of deep learning. The detector 450 can be a Boltzmann machine, a convolutional neural network, a recurrent neural network, a fully connected neural network, or some other type of deep learning neural networks. The output of the detector 450 can be an anomaly score 630 indicating a likelihood that an anomaly is present in the input set of sensor statistics 402.

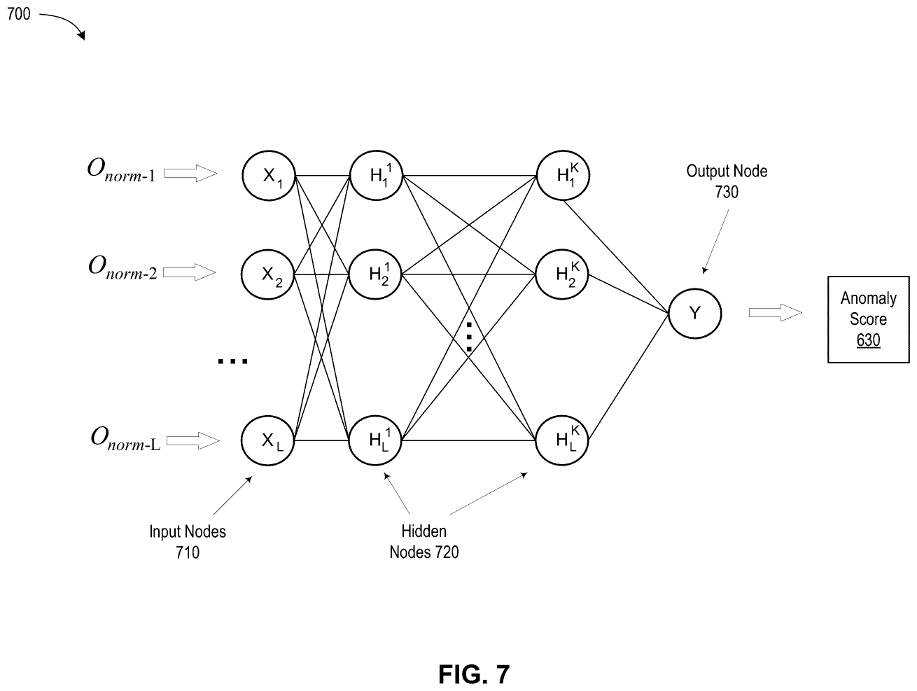

FIG. 7 is an exemplary neural network 700 that operates as a detector neural network 450 used in the detection stage of anomaly detection based on aggregate statistics using neural networks, in accordance with some implementations of the present disclosure. Depicted in FIG. 7 are the normalized outlier scores Oₙₒᵣₘ₋₁, Oₙₒᵣₘ₋₂, . . . . O_{norm-L} input into a plurality of input nodes (neurons) Xⱼ 710-1, 710-2 . . . 710-L) of the detector 450. In some implementations, the neural network 500 can be a restricted Boltzmann machine (RBM). The input normalized outlier scores can be processed by one or more hidden layers having hidden nodes (neurons) 720. Each hidden node 720 can be associated with a hidden variable Hⱼ^{k}. Connections between adjacent columns of the RBM can have associated weights described by a weight matrix Wₗₘ having a value corresponding to a connection between l-th node of one layer with the m-th node of the adjacent layer. In the implementation depicted in FIG. 7, the weight matrix between the input and hidden layers are square matrices (since the number of nodes in each layer is L), but in other implementations, the number of nodes in each consecutive layer can be different from the number of nodes in the previous layer. Additionally, each layer can be associated with a set (vector, column) of biases b₁, b₂, . . .

The RBM can be described by the “energy” symbolically written in the form,

$$E ( \{ {X}_{j} \} , \{ {H}_{j}^{k} \} ) = - \hat{b} \cdot \hat{ξ} - \hat{ξ} \cdot \hat{W} \cdot \hat{ξ} ,$$

where \hat{ξ} denotes the vectors of variables (input X or hidden H) in various layers of the RGB, \hat{b} denotes the biases associated with the corresponding variables (nodes), and Ŵ stands for the weight matrices between the layers. The energy determines the probability of the configuration {Xⱼ}, {Hⱼ^{k}} according to the Boltzmann distribution,

$$P ( \{ {X}_{j} \} , \{ {H}_{j}^{k} \} ) = {Z}^{- 1} exp ( - E ( \{ {X}_{j} \} , \{ {H}_{j}^{k} \} ) ) ,$$

where Z is the partition function (normalization coefficient). Training of a two-layer RBM can be performed using training input vectors (outlier scores) where (1) the hidden variables are statistically determined from the input outlier scores, and (2) the hidden variables are used to reversely predict the value of the input nodes (this (1)+(2) procedure can be repeated a pre-set number of times) before the reversely-predicted input variables are compared to the actual input variables and the biases and weights of the RBM are adjusted until the two sets of the input variables are sufficiently close to each other (e.g., less than a pre-determined accuracy threshold).

In a deep learning RGB with multiple hidden layers, as depicted in FIG. 7, for example, a hidden layer is an input into the successive hidden layer. In some implementations, the hidden layers of the RGB are trained one at a time, e.g., from left to right, in a layer-wise fashion. Specifically, the hidden variables H₁², H₂² . . . . H_{L}² are determined from the values H₁¹, H₂¹ . . . . H_{L}¹, and so on. Such RGB architecture can be capable of disentangling factors of variation in the inputs. Namely, with the propagation through the RGB the hidden nodes can become less statistically dependent. Propagation of the data through the RGB can, therefore, reduce the conditional dependence of the nodes while preserving most of the information about the anomaly score that is output by the output node Y 730. The output node 730 can be viewed as a single-node hidden layer whose weights and a bias can be determined using the same procedures as described in relation to the hidden nodes 720.

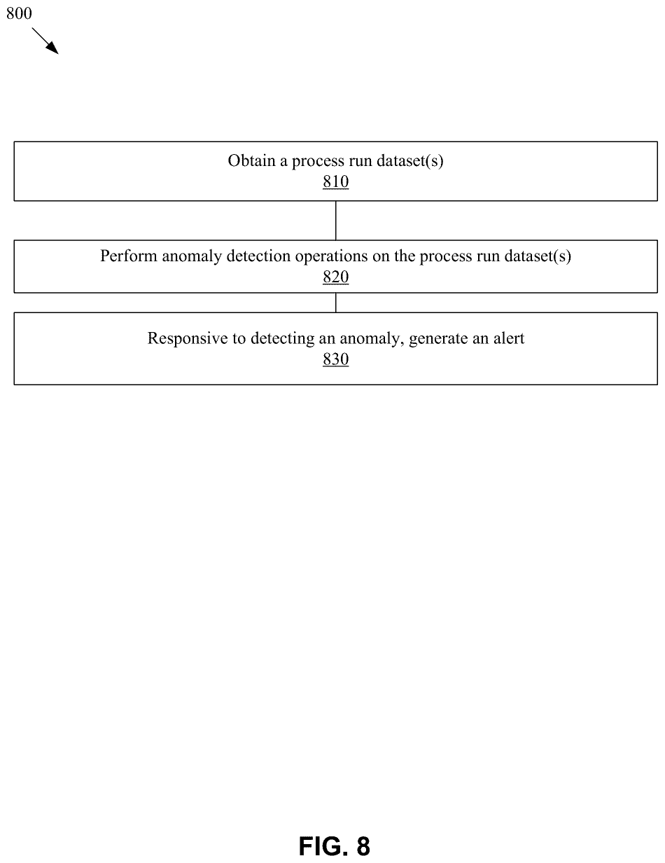

FIG. 8 is a flow chart of a method 800 for generating detecting an anomaly using an ensemble technique system, in accordance with some implementations of the present disclosure. Method 800 is performed by processing logic that can include hardware (circuitry, dedicated logic, etc.), software (such as is run on a general-purpose computer system or a dedicated machine), firmware, or some combination thereof. In one implementation, method 800 can be performed by a computer system, such as computer system architecture 100 of FIG. 1. In other or similar implementations, one or more operations of method 800 can be performed by one or more other machines not depicted in the figures. In some aspects, one or more operations of method 800 can be performed by client device 110 and/or predictive system 160. In some implementations, method 800 relates to detecting an anomaly using an ensemble technique system, such as ADE.

At operation 810, processing logic obtains a process run dataset(s). In particular, each run of a process recipe on a substrate can generate a collection of data items (e.g., sensor data, statistics data, task data, contextual data, etc.), referred to as a “process run dataset.” In some implementations, the process run datasets can include data from multiple process runs on a set of substrates. For example, the process run datasets can include 100 process run datasets, each dataset includes a collection of data items from the execution of a process recipe on each substrate the set of substrates. In some embodiments, each dataset can include a set of arrays generated from the data items. An array can include a combination of data items according a predefined format or pattern (e.g., step.sensor.statistic).

At operation 820, the processing logic performs anomaly detection operations on the process run dataset(s). In some implementations, the processing logic can perform anomaly detection operations (via ADM 113) on real-time data or near-real time data received from SCM 111 and/or SSM 112. In some implementations, the processing logic can perform the anomaly detection operations on a stored set of data (e.g., historical data from completed process runs).

At operation 830, responsive to detecting an anomaly, the processing logic generates an alert. In an illustrative implementation, the processing logic can obtain a reduced representation of the sensor statistics reflective of the data collected by the sensors by processing the initial representation of the plurality of sensor statistics using a reducer neural network. The processing logic can then generate a plurality of outlier scores, each of the plurality of the outlier scores being obtained by executing a respective outlier detection model. The input into the outlier detection models can be the reduced representation of the sensor statistics. The processing logic can then normalize at least some of the outlier scores and processes the plurality of normalized outlier scores using a detector neural network. The detector neural network can be a reduced Boltzmann machine network. In some implementations, the reduced Boltzmann machine network can have two or more hidden layers to generate an anomaly score indicative of a likelihood of an anomaly associated with the manufacturing operation.

In some implementations, the alert can include data indicate which process step, which sensor, which sub-system, which process chamber, etc. correlates to the anomaly. For example, responsive to an anomaly being detected from data obtained from sensor A of process chamber B during a particular step of process recipe C, the alert can indicate such.

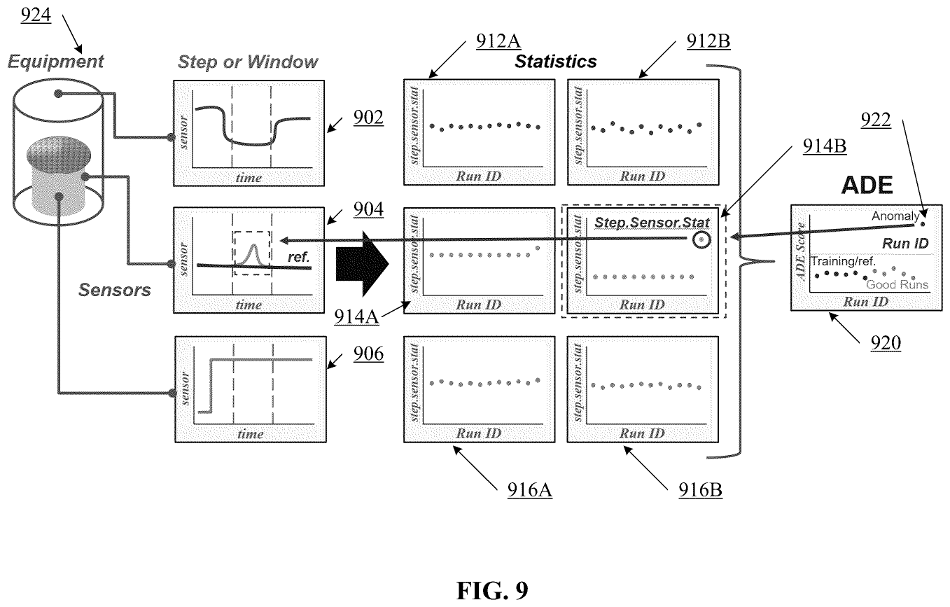

FIG. 9 is a diagram illustrating an ADE system detecting an anomaly. In particular, manufacturing equipment 924 performs steps associated with a process run of a process recipe and generates various sensor data 902, 904, 906. The sensor data can include trace data (e.g., data over time). For each process run, the ADE system can generate a process run dataset that includes statistics data. As shown, statistics data 912A, 912B is generated from sensor data 902, statistics data 914A, 914B is generated from sensor data 904, and statistics data 916A, 916B is generated from sensor data 906. The ADE system can perform anomaly detection operations on the process run datasets and detect an anomaly 922 as shown in graph 920.

FIGS. 10A-D are flow diagrams of methods 1000A-D associated with guardbands, in accordance with some implementations of the present disclosure. In some implementations, methods 1000A-D are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In some implementations, methods 1000A-D are performed, at least in part, by predictive system 160 and/or client device 110. In some implementations, a non-transitory storage medium stores instructions that when executed by a processing device (e.g., of predictive system 160, of server machine 180, of predictive server 1105, etc.) cause the processing device to perform one or more of methods 1000A-D.

For simplicity of explanation, methods 1000A-D are depicted and described as a series of operations. However, operations in accordance with this disclosure can occur in various orders and/or concurrently and with other operations not presented and described herein. Furthermore, in some implementations, not all illustrated operations are performed to implement methods 1000A-D in accordance with the disclosed subject matter. In addition, those skilled in the art will understand and appreciate that methods 1000A-D could alternatively be represented as a series of interrelated states via a state diagram or events.

In some implementations, FIGS. 10A-D are directed to sequential data guardband analysis for improved fault diagnostics, fault classification, and prediction (e.g., sequential guardband analysis for fault detection and classification (FDC)). In some implementations, the present disclosure provides improves analysis of a sequential data stream (e.g., trace data) using guardband fault diagnostics full trace analysis (FTA) to provide improved detection, classification, and prediction including reduced false alarms (e.g., false positives) and missed alarms (e.g., missed positives). The present disclosure may use guardbands to analyze both transient and steady-state regions and to extract complex features (e.g., more complex than unique variable analysis (UVA)).

A guardband of the present disclosure may be used to detect anomalies or faults that occur in trace data but may not conform to a typical anomaly shape such as a spike or oscillation. Guardbands of the present disclosure may be provided in isolation or may be combined with other analysis capabilities such as semi-automated feature extraction (SFE).

A guardband may be a channel defined for a data stream that is meant to identify a region of commonality (e.g., acceptable values) as a function of the position in the data stream. The data stream (e.g., trace data) is often the value of a sensor over the course of some event such as a production run. For example, the data stream can be a sequence of data values presented and positioned as a function of time (e.g., x-axis is time). The sequencing may not be time based (e.g., may be an indication of count of something such as number of products produced or number of errors logged). The term “acceptable” is a function of the application environment and objective of the guardband analysis. For example, “acceptable” could be “not-anomalous” or “not-faulty.” The guardband channel may have an upper and lower limit. In some implementations, these limits may be calculated using statistical methods along the duration of the data stream. For example, the channel could represent+/−3-sigma of the value of multiple traces of a particular sensor, where variance is calculated at each time value of the data stream. Smoothing techniques (e.g., time window averaging) may be employed to allow the channel to be more noise resistant and smooth.

FTA guardbanding may be used for anomaly trace with minor oscillation at transient segments. FTA guardbanding may be used to analyze multiple traces or trace partition from a particular sensor over multiple runs. FTA guardbanding may establish upper and lower limits that indicate a normal range or channel for the sensor data over time (e.g., 3-sigma). The solution identifies and profiles excursions from the guardband. FTA capability can be used along with SFE in a complementary fashion to provide for comprehensive analysis and as input to a fingerprint library. A guardband can be associated with a single sensor (UVA) or across multiple sensors (multivariate analysis (MVA)). For MVA, the sensor value (e.g., y-axis) may be a metric that represents some combination of the sensors involved in the MVA.

In some implementations, a guardband may include multiple guardbands (e.g., a warning guardband fully contained within an error guardband). In some implementations, a first area is a normal region regardless of other parameters, a second area is a region where classification of good or bad is based on analysis of other parameters, and a third area is a faulty region regardless of other parameters.

In some implementations, the x-axis parameter of the guardband or the parameter that defines sequencing aspect of the data is time (e.g., granularly associated with the sensor(s) read rate). In some implementations, a substrate number in a process tool may correspond to substrate processes.

In some implementations, the guardband violation definition may be an anomaly, fault, warning, event trigger, and/or prediction. Guardband violation determination and interpretation may relate to the purpose of the guardband (e.g., fault or anomaly detection). A single data point outside of the guardband channel may indicate a fault. A probability distribution function may be used to define the area, duration, and magnitudes of portions that includes violation areas in the trace. These violation areas may be evaluated (e.g., violation area attribute values) to interpret if there is a fault.

FIGS. 10A-D are flow diagrams of methods 1000A-D associated with generating a guardband, according to certain implementations. FIG. 10A is a flow diagram of a method 1000A associated with generating a guardband, FIG. 10B is a flow diagram of a method 1000B associated with using a guardband, FIG. 10C is a flow diagram of a method 1000C associated with generating a guardband via machine-learning (e.g., via a model 190), and FIG. 10D is a flow diagram of a method 1000D associated with using a guardband via machine-learning (e.g., via a model 190).

Referring to FIG. 10A, in some implementations, at block 1002, the processing logic identifies trace data associated with production, via a substrate processing system, of substrates (e.g., good substrates) that have property values that meet threshold values. Trace data includes a separate set of sensor data over time for each of the substrates. In some implementations, trace data includes sensor data (e.g., different types of sensor data) from multiple different sensors for each of the substrates.

At block 1004, the processing logic determines, based on the trace data, allowable types of variance (e.g., of a guardband).

In some implementations, processing logic generates a guardband based on the trace data. The guardband may include an upper limit and a lower limit for fault detection (e.g., anomaly detection). In some implementations, to form a guardband, an average of all of the trace data is generated and then offsets from the average (e.g., three sigma) is used as the upper limit and the lower limit. In some implementations, the upper limit and the lower limit are equally distanced from the average of the trace data. Since the trace data is for good substrates, any variations from the guardband formed by the trace data are allowable types of variance.

In some implementations, block 1004 includes processing logic determining trace-to-trace variability of the trace data at block 1010. In some implementations, the allowable types of variance include trace-to-trace variability of time shifts. The trace data may include sensor values (e.g., y-axis) over time (e.g., x-axis). Due to differing times of starting to record the sensor data, some of the sets of sensor data over time may be offset (e.g., time shift, in the x-axis). In some implementations, the processing logic tracks trace-to-trace differences and autonomously adjusts guardband variance horizontally when a normal time shifting variance is found. This prevents false positives when a recipe step or trace slightly shifts. This increases the robustness and reduces false positives.

In some implementations, block 1004 includes processing logic determining an upper limit different from a lower limit based on the trace data at block 1012. In some implementations, the allowable types of variance include a first allowable type of variance to form the upper limit of the guardband and a second allowable type of variance to form the lower limit of the guardband. The first allowable type (e.g., quantity) of variance may be different from the second allowable type (e.g., quantity) of variance. Variation on each side of the guardband is to be computed separately (e.g., during signal transitions) and reduces false positives.

In some implementations, block 1004 includes processing logic determining position-dependent variance of the trace data at block 1014. Parameters and weighting (e.g., duration, level, area, concatenation of successive violations, etc.) and other guardband settings can be adjusted as a function of the position (e.g., along x-axis) in the guardband. Examples include: 1) adjusting along the x-axis corresponding to different operations along a process so the guardband is more/less sensitive or adaptive; 2) adjusting guardband as a function of the characteristics of the signal (e.g., less aggressive in an area where guardband is changing rapidly in the y-direction and more aggressive in an area where the guardband value is relatively constant); 3) adjusting guardband as a function of alarms detected along the guardband (e.g., adjusting the distribution parameters after a first spike is detected to be more or less sensitive to future spike features on that trace); etc. This improves guardband performance and further allows subject matter expertise incorporation into guardband analysis.

In some implementations, block 1004 includes processing logic determining trace segmentation of the trace data at block 1016. In some implementations, the allowable types of variance are further based on segmentation of portions of the trace data (e.g., associated with change in values that exceeds a threshold change, values within the threshold). For example, a feature (e.g., within a threshold) may trigger a wider guardband for a next segment of the guardband. In some implementations, the allowable types of variance are further based on extraction of features from the trace data.

In some implementations, block 1004 includes processing logic performing feature extraction (e.g., semi-auto feature extraction (SFE)) of the trace data at block 1018. For example, the guardband parameters may be changed for different segments or for different features. This improves guardband performance and overall analysis by allowing the combining of different capabilities (e.g., guardband, feature extraction, and/or trace segmentation).

In some implementations, the trace data includes sensor data from different types of sensors and the allowable types of variance is via MVA. MVA metric combining values of multiple sensors into a single metric (e.g., first principal component in principal component analysis (PCA)). Guardband parameters may be applied across multiple guardbands using MVA techniques. Examples include: 1) determining violations and violation distributions as function of violation characteristics across two or more traces occurring (or not occurring) simultaneously; and/or 2) dynamics associated with a guardband for a signal based on that signal for one or more other signals. This improves guardband performance, further allows subject matter expertise incorporation into guardband analysis, and allows addressing of correlation across multiple signals.

In some implementations, the features include one or more of: persistent features (e.g., ramps and flats); user defined features (e.g., concatenation of ramps and slopes); intermittent features, such as ramps, flats, and FTA features; x-offset; y-offset; shape; length; warping; etc.

At block 1005, the processing logic generates, based on the allowable types of variance, a guardband. For example, the guardband may allow for time shifts (e.g., in the x-axis), upper limit and lower limit that are different, multi-variable (e.g., multi-variate) analysis, segmentation of portions of the trace data, extraction of features of the trace data, etc. In some implementations, the guardband is generated by training a machine-learning model, as shown in FIG. 10C.

At block 1008, the processing logic causes, based on the guardband, performance of a corrective action associated with the substrate processing system. Block 1008 may include comparing additional trace data to the guardband to determine whether to perform the corrective action (e.g., see FIG. 10B).

Referring to FIG. 10B, in some implementations, at block 1022, the processing logic identifies trace data associated with substrate production via a substrate processing system (e.g., the same substrate processing system as FIG. 10A). The trace data may be associated with substrates that is unknown whether the property data of the substrates meets threshold values (e.g., good substrates) or do not meet threshold values (e.g., bad substrates). Trace data includes a separate set of sensor data over time for each of the substrates. In some implementations, trace data includes sensor data (e.g., different types of sensor data) from multiple different sensors for each of the substrates.

At block 1024, the processing logic compares the trace data to a guardband that has been generated based on allowable types of variance (e.g., see block 1006 of FIG. 10A). The guardband may have an upper limit and a lower limit for data points over time.

At block 1026, the processing logic determines one or more data points of the trace data are not within the guardband. The one or more data points may include at least one data point above the upper limit and/or at least one data point below the lower limit (e.g., the data points do not match data points of substrates that have property values that meet threshold values).

At block 1028, processing logic causes performance of a corrective action associated with the substrate processing system. In some implementations, the corrective action includes providing an alert, interrupting substrate processing equipment, causing inspection of the substrate, discarding the substrate, updating manufacturing parameters, etc. In some implementations, the performance of the corrective action is specific to the type or quantity of data points that are outside of the guardband.

Referring to FIG. 10C, in some implementations, at block 1042, the processing logic identifies historical trace data associated with production, via a substrate processing system, of substrates. In some implementations, the substrates (e.g., good substrates) have property values that meet threshold values. Block 1042 may be similar to block 1002 of FIG. 10A. In some implementations, the substrates (e.g., bad substrates) have property values that do not meet threshold values.

In some implementations, at block 1044, the processing logic identifies historical performance data associated with the historical trace data. In some examples, the historical performance data is indicates whether the substrates are good substrates or are bad substrates (e.g., all the substrates have property values that meet threshold values, all of the substrates have property values that do not meet threshold values).

At block 1046, the processing logic trains a machine-learning model with data input including the historical trace data (e.g., and target output including the historical performance data) to generate a trained machine-learning model indicative of a guardband associated with allowable types of variance. The training of the machine-learning model may cause the guardband to be based on the allowable types of variance described in block 1004 of FIG. 10A.

The trained machine-learning model may be used to determine whether additional trace data meets the guardband (e.g., see FIG. 10D).

Referring to FIG. 10D, in some implementations, at block 1062, the processing logic identifies trace data associated with substrate production via a substrate processing system (e.g., the same substrate processing system as FIG. 10C). The trace data may be associated with substrates that is unknown whether the property data of the substrates meets threshold values (e.g., good substrates) or do not meet threshold values (e.g., bad substrates). Block 1062 may be similar to block 1042 of FIG. 10B.

At block 1064, the processing logic provides the trace data as input to a trained machine-learning model (e.g., trained machine-learning model of FIG. 1046 of FIG. 10C) associated with a guardband generated based on allowable types of variance.

At block 1066, the processing logic receives from the trained machine-learning model, output indicative of predictive data.

At block 1068, the processing logic determines, based on the predictive data, that one or more data points of the trace data are not within the guardband of the trained machine-learning model. The one or more data points may be above the upper limit of the guardband or may be below the lower limit of the guardband.

At block 1070, the processing logic causes, based on the predictive data, performance of a corrective action associated with the substrate processing system. Block 1070 may be similar to block 1028 of FIG. 10B.

FIG. 11 illustrates an example guardband violation profiling, in accordance with some implementations of the present disclosure. Graph 1100 illustrates trace data for production of a substrate. Graph 1100 also illustrates a guardband that include an upper limit 1106 and a lower limit 1104. Reference data 1102 (e.g., baseline data obtained from training sets) can be used to generate the threshold values. Trace data 1108 can include data obtained from a process run, and sets of data points that fall outside of the guardband limits can be referred to as sets of guardband violation data points 1110A. 1110B (e.g., sets of data points associated with guardband violation). These sets of guardband violation data points 1110A, 1110B that can be indicative of a bad substrate, or indicative of a false positives. Violation segment 1112 indicates the section where the violation data points occurred.

FIG. 12 is a diagram of the framework for building (e.g., training) a trace shape classifier model, according to aspects of the present disclosure. A classifier training set can be selected to train the trace shape classifier. In particular, each run of a process recipe on a substrate can generate a collection of data items, referred to as a “process run dataset” (e.g., sensor data, statistics data, task data, contextual data, etc.). The classifier training set can include process run dataset from multiple process runs on a set of substrates. For example, the classifier training set can include 100 process run datasets, each dataset includes a collection of data items from the execution of a process recipe on each substrate the set of substrates. In some embodiments, each classifier training set can include a set of arrays generated from the data items. An array can include a combination of data items according a predefined format or pattern (e.g., step.sensor.statistic).

Simulated anomaly data 1204 can be added to distort or modify one or more parameters of the training set. The one or more parameters can be modified based on user input, a certain percentage, a certain value, randomly modified, etc. In some implementations, simulated anomaly data 1204 can include a shape label (e.g., Offset, spike, oscillation, noise, shark fin, etc.). In some implementations, simulated anomaly data 1204 can include, or be generated from, the data stored in data store 140. The anomalous training set (e.g., training set modified with simulate anomaly data) can be used as input to ADE 1210 and Guardband 1220. ADE 1210 can generate data items 1212 and ADE statistics 1214. Data items 1212 can identify the step of the process run that contains the anomaly, the sensor that generated the anomalous data, etc. The ADE output data can include any data generated by the ADE 1210, such as, for example, the continuous or quasi-continuous anomaly score (e.g., a value within the 0.0 to 1.0 range, or 0 to 100 range, or any other range). Guardband 1220 can Guardband output data 1222. The Guardband output data can include any output data generated by Guardband 1220, such as, for example, feature data associated with the anomaly. The feature data can include, for example, persistent features (e.g., ramps and flats), user defined features (e.g., concatenation of ramps and slopes), intermittent features, such as ramps, flats, and FTA features, x-offset, y-offset, shape, length, warping, etc.

The ADE statistics 1214 and the guardband statistics 1222 can be used to train trace shape classifier 1230, which can be a machine-learning model 190. For example, ADE statistics 1214 and the guardband statistics 1222, can be used as training data for generating trace shape classifier 1230. In an illustrative example, the training data (e.g., ADE statistics 1214 and the guardband statistics 1222) is provided to training engine 182 of server machine 180 to perform the training. In the case of a neural network, for example, input values of a given input/output mapping are input to the neural network, and output values of the input/output mapping are stored in the output nodes of the neural network. The connection weights in the neural network are then adjusted in accordance with a learning algorithm (e.g., backpropagation, etc.), and the procedure is repeated for the other input/output mappings in the training data. The input values can include ADE statistics 1214 and the guardband statistics 1222 and the output values can include an indication of a trace shape. Once trained, trace shape classifier 1230 can be used to receive anomalous data identified by ADE 1210 and/or guardband 1220, and output predictive data indicative of a trace shape of the anomalous data.

FIG. 13 is a flow chart of a method 1300 for detecting an anomaly and applying a trace shape classifier model to anomalous current trace data to classify an anomalous trace shape, according to aspects of the present disclosure. Method 1300 is performed by processing logic that can include hardware (circuitry, dedicated logic, etc.), software (such as is run on a general-purpose computer system or a dedicated machine), firmware, or some combination thereof. In one implementation, method 1300 can be performed by a computer system, such as computer system architecture 100 of FIG. 1. In other or similar implementations, one or more operations of method 1300 can be performed by one or more other machines not depicted in the figures. In some aspects, one or more operations of method 1300 can be performed by client device 110, model generation system 150, server machine 170, server machine 180, and/or predictive server 195.

At operation 1310, processing logic receives current trace data related to a process run. The current trace data can be associated with a manufacturing operation.

At operation 1320, processing logic provides, as input data, the current trace data to a first predictive subsystem, such as, for example, a first anomaly detection model. In some implementations, the first anomaly detection model can be generated (and/or trained) using the machine-learning system discussed in FIGS. 4-7. In particular, the first anomaly detection model can include a machine-learning model configured to perform anomaly detection using ensemble techniques (e.g., an ADE model). In some implementations, the first anomaly detection model can perform anomaly detection operations (via ADM 113) on the current trace data.

At operation 1330, processing logic determines whether the first anomaly detection model detected an anomaly in the current trace data. For example, the processing logic can generate output data indicative of an anomaly score and determine whether the anomaly score is indicative of a likelihood of an anomaly associated with the manufacturing operation. More specifically, the output data can include, for example, the continuous or quasi-continuous anomaly score (e.g., a value within the 0.0 to 1.0 range, or 0 to 100 range, or any other range). The anomaly score than then be compared to a threshold criterion to determine whether the current trace data comprises an anomaly, Responsive to the processing logic failing to detect an anomaly, the processing logic proceeds to operation 1310 to receive subsequent current trace data. Responsive to the processing logic detecting an anomaly, the processing logic proceeds to operation 1340.

At operation 1340, processing logic provides, as input data, the current trace data to a second predictive subsystem, such as, for example, a second anomaly detection model. In some implementations, the second anomaly detection model can be generated (and/or trained) using the methods discussed in FIGS. 10A-10D. In particular, the second anomaly detection model can include a machine-learning model configured to perform anomaly detection using guardband techniques (e.g., a Guardband model). In some implementations, the second anomaly detection model can perform anomaly detection operations (via ADM 113) on the current trace data. The processing logic can obtain, from the second anomaly detection model, output data. In some implementations, the output data can include feature data associated with the anomaly, such as, for example, persistent features (e.g., ramps and flats), user defined features (e.g., concatenation of ramps and slopes), intermittent features, such as ramps, flats, and FTA features, x-offset, y-offset, shape, length, warping, etc. In some implementations, the output data can include only violation trace data (e.g., trace data that went outside the guardband limits).

At operation 1350, the processing logic provides, as input to a third predictive subsystem (e.g., a trace shape classifier model), the output data from the first anomaly detection model and the output data from the second anomaly detection model.

At operation 1360, the processing logic obtains, from the trace shape classifier model, output data indicative of the trace shape associated with the anomaly.

At operation 1370, the processing logic obtains identification data associated with the trace shape. The identification data can identify the type of trace shape, the type of issue associated with trace shape, the cause of the anomaly, etc. In some implementations, the processing logic can perform a lookup of a data structure stored on data store 140 to compare the trace shape to known trace shapes and their related types of issues, causes, etc. The identification data can be presented to a user in, for example, a display message.

At operation 1380, the processing logic performs one or more corrective action based on the trace shape. For example, the processing logic can alert the user and advice the user of various corrective options, such as changing parameters of the manufacturing process, pausing the manufacturing process (e.g., for a quick maintenance), stopping the manufacturing process (e.g., for more extensive repairs), or the like. In some implementations, the processing device can take multiple remediation actions, e.g., adjust settings of the manufacturing process, schedule maintenance, and alert the user. In particular, the processing logic can generate a corrective action or updated a process recipe, based on the anomalous trace shape, by adjusting the parameters associated with the manufacturing process or values associated with the process recipe. For example, a correction profile having one or more adjustments can be applied to one or more steps of the current deposition process or a process recipe. This can be performed in response to user input, or automatically based on one or more predefined conditions (e.g., a sensor value satisfying a threshold criterion, such as a threshold value). Thus, the processing logic can perform, on the substrate, a subsequent step of the process recipe according to the updated process recipe. In some implementations, the subsequent step comprises another deposition step, another etch step, etc. In some implementations, the update process recipe can be used to perform additional deposition steps, additional etch steps, etc. on the substrate. Accordingly, the manufacturing process recipe can be adjusted in real or near real-time.

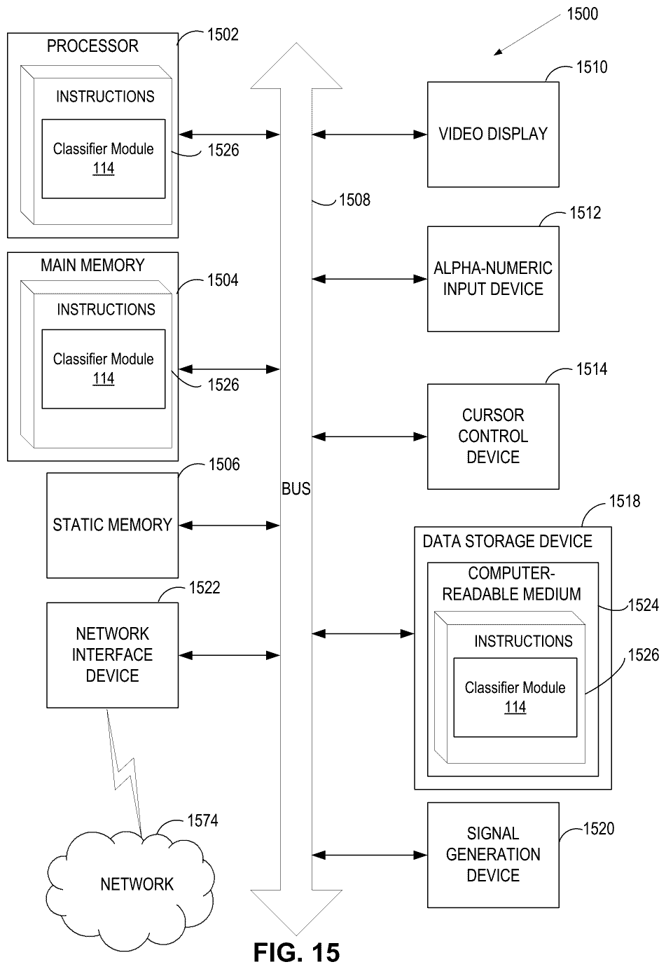

FIG. 15 is a block diagram illustrating a computer system 1500, according to certain implementations. In some implementations, computer system 1500 can be connected (e.g., via a network, such as a Local Area Network (LAN), an intranet, an extranet, or the Internet) to other computer systems. Computer system 1500 can operate in the capacity of a server or a client computer in a client-server environment, or as a peer computer in a peer-to-peer or distributed network environment. Computer system 1500 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1500 can include a processing device 1502, a volatile memory 1504 (e.g., Random Access Memory (RAM)), a non-volatile memory 1506 (e.g., Read-Only Memory (ROM) or Electrically-Erasable Programmable ROM (EEPROM)), and a data storage device 1516, which can communicate with each other via a bus 1508.

Processing device 1502 can be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 1500 can further include a network interface device 1522 (e.g., coupled to network 1574). Computer system 1500 also can include a video display unit 1510 (e.g., an LCD), an alphanumeric input device 1512 (e.g., a keyboard), a cursor control device 1514 (e.g., a mouse), and a signal generation device 1520.

In some implementations, data storage device 1516 can include a non-transitory computer-readable storage medium 1524 on which can store instructions 1526 encoding any one or more of the methods or functions described herein, including instructions encoding components of FIG. 1 (e.g., SCM 111, SSM 112, ADM 113, classifier module 114, and corrective action module 117, etc.) and for implementing methods described herein.

Instructions 1526 can also reside, completely or partially, within volatile memory 1504 and/or within processing device 1502 during execution thereof by computer system 1500, hence, volatile memory 1504 and processing device 1502 can also constitute machine-readable storage media.

While computer-readable storage medium 1524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and can not have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method, comprising:
obtaining current trace data associated with a substrate processing system;
providing the trace data as input to a first predictive subsystem trained to detect anomalies using a first technique;
responsive to detecting an anomaly in the trace data, providing the trace data as input to a second predictive subsystem trained to detect anomalies using a second technique;
providing output data obtained from the first predictive subsystem and the second predictive subsystem to a third predictive subsystem;
obtaining, from the third predictive subsystem, output data reflective of a trace shape associated with the anomaly; and
identifying, based on the trace shape, a type of issue that caused the anomaly in the trace data.

2. The method of claim 1, wherein the first technique comprises an ensemble technique associated with using sensor statistics to establish a baseline set of values and detecting one or more outliers that deviate by a threshold value from the baseline set of values.

3. The method of claim 1, wherein the second technique comprises a trace analysis technique associated with using adaptive upper and lower limits around a set of target values.

4. The method of claim 1, further comprising:
determining a root cause of the anomaly; and
performing at least one of generating an alert or performing a corrective action.

5. The method of claim 1, wherein the type of issue is determined by performing a lookup of the trace shape in a data structure.

6. The method of claim 1, wherein the trace shape comprises at least one of an offset shape, a spike shape, an oscillation shape, a noise shape, or a shark fin shape.

7. The method of claim 1, wherein the third predictive subsystem is trained on a set of process runs each modified with labeled anomaly data.

8. A system, comprising:
a memory device; and
a processing device, operatively coupled to the memory device, to perform operations comprising:
obtaining current trace data associated with a substrate processing system;
providing the trace data as input to a first predictive subsystem trained to detect anomalies using a first technique;
responsive to detecting an anomaly in the trace data, providing the trace data as input to a second predictive subsystem trained to detect anomalies using a second technique;
providing output data obtained from the first predictive subsystem and the second predictive subsystem to a third predictive subsystem;
obtaining, from the third predictive subsystem, output data reflective of a trace shape associated with the anomaly; and
identifying, based on the trace shape, a type of issue that caused the anomaly in the trace data.

9. The system of claim 8, wherein the first technique comprises an ensemble technique associated with using sensor statistics to establish a baseline set of values and detecting one or more outliers that deviate by a threshold value from the baseline set of values.

10. The system of claim 8, wherein the second technique comprise a trace analysis technique associated with using adaptive upper and lower limits around a set of target values.

11. The system of claim 8, wherein the operations further comprise:
determining a root cause of the anomaly; and
performing at least one of generating an alert or performing a corrective action.

12. The system of claim 8, wherein the type of issue is determined by performing a lookup of the trace shape in a data structure.

13. The system of claim 8, wherein the trace shape comprises at least one of an offset shape, a spike shape, an oscillation shape, a noise shape, or a shark fin shape.

14. The system of claim 8, wherein the third predictive subsystem is trained on a set of process runs modified with labeled anomaly data.

15. A non-transitory computer-readable storage medium comprising instructions that, when executed by a processing device operatively coupled to a memory, performs operations comprising:
obtaining current trace data associated with a substrate processing system;
providing the trace data as input to a first predictive subsystem trained to detect anomalies using a first technique;
responsive to detecting an anomaly in the trace data, providing the trace data as input to a second predictive subsystem trained to detect anomalies using a second technique;
providing output data obtained from the first predictive subsystem and the second predictive subsystem to a third predictive subsystem;
obtaining, from the third predictive subsystem, output data reflective of a trace shape associated with the anomaly; and
identifying, based on the trace shape, a type of issue that caused the anomaly in the trace data.

16. The non-transitory computer-readable storage medium of claim 15, wherein the first technique comprises an ensemble technique associated with using sensor statistics to establish a baseline set of values and detecting one or more outliers that deviate by a threshold value from the baseline set of values.

17. The non-transitory computer-readable storage medium of claim 15, wherein the second technique comprise a trace analysis technique associated with using adaptive upper and lower limits around a set of target values.

18. The non-transitory computer-readable storage medium of claim 15, wherein the operations further comprise:
determining a root cause of the anomaly; and
performing at least one of generating an alert or performing a corrective action.

19. The non-transitory computer-readable storage medium of claim 15, wherein the type of issue is determined by performing a lookup of the trace shape in a data structure.

20. The non-transitory computer-readable storage medium of claim 15, wherein the trace shape comprises at least one of an offset shape, a spike shape, an oscillation shape, a noise shape, or a shark fin shape.
